(19) United States
(12) Patent Application Publication
(10) Pub. No.: US 2026/0264401 A1
(43) Pub. Date: Sep. 10, 2026

(54) PASSIVE VALVES IN A PRINTHEAD

(71) Applicant: Nasser Budraa, La Crescenta, CA (US)

(72) Inventor: Nasser Budraa, La Crescenta, CA (US)

(73) Assignee: Ricoh Company, Ltd., Tokyo (JP)

(21) Appl. No.: 19/074,407

(22) Filed: Mar. 9, 2025

(51) Int. Cl. B41J 2/14; B41J 2/16

(52) U.S. Cl. CPC B41J 2/1433; B41J 2/14201; B41J 2/162; B41J 2002/14306; B41J 2002/14419; B41J 2002/14475

(57) ABSTRACT

Printheads that jet print liquids. In an embodiment, a printhead comprises a housing and a plate stack attached to the housing that forms a plurality of jetting channels comprising pressure chambers and channel fluid passages that fluidly couple the pressure chambers to a common manifold, and passive valves disposed in the channel fluid passages. The passive valves are configured to inhibit a back flow of print liquid from the pressure chambers towards the common manifold and allow a flow of the print liquid from the common manifold towards the pressure chambers. At least one plate of the plate stack comprises fixed valve members that are disposed within the channel fluid passages to form the passive valves.

### TECHNICAL FIELD

The following disclosure relates to the field of image formation, and in particular, to printheads and/or the design of printheads.

### BACKGROUND

Image formation is a procedure whereby a digital image (e.g., a 2D image, a 3D image or model, etc.) is recreated by propelling droplets of ink or another type of print liquid onto a medium, such as paper, plastic, a substrate for 3D printing, etc. Image formation is commonly employed in apparatuses, such as printers (e.g., inkjet printer, 3D printer, etc.), facsimile machines, copying machines, plotting machines, multifunction peripherals, etc. The core of a typical jetting apparatus or image forming apparatus is one or more liquid-droplet ejection heads (referred to generally herein as “printheads”) having nozzles that discharge liquid droplets, a mechanism for moving the printhead and/or the medium in relation to one another, and a controller that controls how liquid is discharged from the individual nozzles of the printhead onto the medium in the form of pixels or dots.

A typical printhead includes a plurality of nozzles aligned in one or more rows along a discharge surface of the printhead. Each nozzle is part of a “jetting channel”, which includes the nozzle, a pressure chamber, and a diaphragm that vibrates in response to an actuator, such as a piezoelectric actuator. A printhead also includes a driver circuit that controls when each individual jetting channel fires based on image or print data. To jet from a jetting channel, the driver circuit provides one or more jetting pulses to the actuator, which cause the actuator to deform a wall of the pressure chamber (i.e., the diaphragm). The deformation of the pressure chamber creates pressure waves within the pressure chamber that eject one or more droplets of print liquid (e.g., ink) out of the nozzle.

Several characteristics may determine jetting quality from jetting channels of a printhead. Thus, it is beneficial to continue to develop structures that enhance jetting quality.

### SUMMARY

Embodiments described herein provide for one or more passive valves disposed in channel fluid passages (also referred to as restrictors) disposed between a common manifold and pressure chambers of a printhead. One technical benefit is a passive valve of a jetting channel restricts or confines applied energy from an actuator to the pressure chamber. Thus, the applied energy is focused on jetting of droplets from the nozzle of the jetting channel, which increases jetting efficiency and allows for the use of lower voltages when driving the actuator.

In an embodiment (also referred to as aspects), a printhead comprises a housing and a plate stack attached to the housing that forms a plurality of jetting channels comprising pressure chambers and channel fluid passages that fluidly couple the pressure chambers to a common manifold, and passive valves disposed in the channel fluid passages. The passive valves are configured to inhibit a back flow of print liquid from the pressure chambers towards the common manifold and allow a flow of the print liquid from the common manifold towards the pressure chambers. At least one plate of the plate stack comprises fixed valve members that are disposed within the channel fluid passages to form the passive valves.

In an embodiment, a printhead comprises a housing and a plate stack attached to the housing that forms a plurality of jetting channels comprising pressure chambers, first channel fluid passages that fluidly couple the pressure chambers to a first common manifold, and second channel fluid passages that fluidly couple the pressure chambers to a second common manifold, and passive valves comprising first passive valves disposed in the first channel fluid passages and second passive valves disposed in the second channel fluid passages. The first passive valves are configured to inhibit a back flow of print liquid from the pressure chambers towards the first common manifold and allow a flow of the print liquid from the first common manifold towards the pressure chambers. The second passive valves are configured to inhibit a back flow of the print liquid from the second common manifold towards the pressure chambers and allow a flow of the print liquid from the pressure chambers towards the second common manifold. A first plate of the plate stack comprises fixed valve members that are disposed within the first channel fluid passages to form the first passive valves, and a second plate of the plate stack comprises the fixed valve members that are disposed within the second channel fluid passages to form the second passive valves.

In an embodiment, a method of fabricating a printhead comprises obtaining a housing and a plurality of plates for the printhead, forming fixed valve members on one or more of the plates, and assembling the plates into a plate stack attached to the housing. The plate stack when assembled forms a plurality of jetting channels comprising pressure chambers and channel fluid passages that fluidly couple the pressure chambers to a common manifold, and passive valves disposed in the channel fluid passages. The passive valves are configured to inhibit a back flow of print liquid from the pressure chambers towards the common manifold and allow a flow of the print liquid from the common manifold towards the pressure chambers. The fixed valve members disposed within the channel fluid passages form the passive valves.

The above summary provides a basic understanding of some aspects of the specification. This summary is not an extensive overview of the specification. It is intended to neither identify key or critical elements of the specification nor delineate any scope of particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a schematic diagram of a jetting apparatus in an illustrative embodiment.

FIG. 2 is a perspective view of a printhead in an illustrative embodiment.

FIG. 3 is a perspective view of a printhead in an illustrative embodiment.

FIG. 4 is a cross-sectional view of a printhead in an illustrative embodiment.

FIGS. 5A-5B are schematic diagrams of a printhead in illustrative embodiments.

FIG. 6 is a cross-sectional view of a non-flow-through type of printhead in an illustrative embodiment.

FIG. 7 is a perspective view of a jetting channel in an illustrative embodiment.

FIGS. 8A-8D are schematic diagrams of a printhead in illustrative embodiments.

FIGS. 9A-9B are cross-sectional views of flow-through types of printheads in illustrative embodiments.

FIGS. 10A-10B are perspective views of a jetting channel in illustrative embodiments.

FIG. 11 is a schematic diagram of a non-flow-through type of printhead in an illustrative embodiment.

FIGS. 12A-12B are schematic diagrams of flow-through types of printheads in illustrative embodiments.

FIGS. 13A-13B are perspective views of a channel fluid passage with a passive valve in illustrative embodiments.

FIGS. 14A-14B are perspective views of a jetting channel in illustrative embodiments.

FIGS. 15A-15E are cross-sectional views of a channel fluid passage in illustrative embodiments.

FIGS. 16A-16C are cross-sectional views of a channel fluid passage in illustrative embodiments.

FIGS. 17A-17B are flow diagrams illustrating a flow of print liquid through a channel fluid passage in illustrative embodiments.

FIGS. 18A-18B are perspective views of a channel fluid passage with a passive valve in illustrative embodiments.

FIGS. 19A-19B are perspective views of a jetting channel 402 in illustrative embodiments.

FIG. 20 is a flow chart illustrating a method of operating a printhead in an illustrative embodiment.

FIG. 21 is a schematic diagram of a non-flow-through type of printhead in an illustrative embodiment.

FIGS. 22A-22B are schematic diagrams of a flow-through type of printhead in illustrative embodiments.

FIG. 23 illustrates an exploded, perspective view of a head member of a printhead in an illustrative embodiment.

FIGS. 24A-24B are perspective views of a restrictor plate in illustrative embodiments.

FIGS. 25A-25B are perspective views of a support plate in illustrative embodiments.

FIGS. 26A-26B are perspective views of a chamber plate in illustrative embodiments.

FIG. 27 illustrates an exploded, perspective view of a head member of a printhead in an illustrative embodiment.

FIGS. 28A-28B are perspective views of a restrictor plate in illustrative embodiments.

FIGS. 29A-29B are perspective views of a chamber plate in illustrative embodiments.

FIGS. 30A-30B are perspective views of a nozzle plate in illustrative embodiments.

FIG. 31 is a flow chart illustrating a method of fabricating a printhead in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

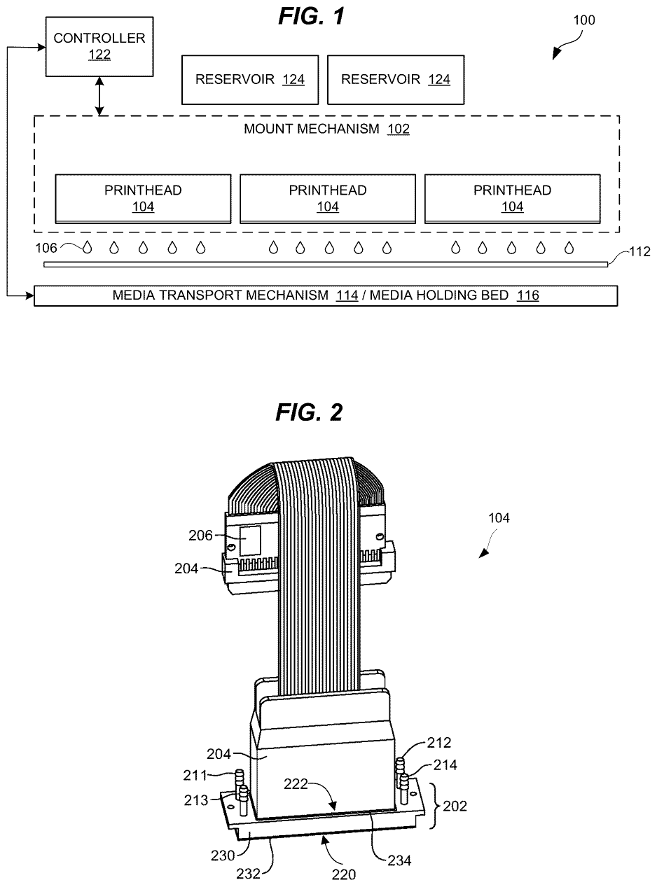

FIG. 1 is a schematic diagram of a jetting apparatus 100 in an illustrative embodiment. A jetting apparatus 100 is an image forming apparatus that uses one or more printheads to eject a print liquid or jetting liquid onto a medium. One example of jetting apparatus 100 is an inkjet printer (e.g., continuous feed or cutsheet printer) that performs single-pass printing. Other examples of jetting apparatus 100 include a scan pass inkjet printer (e.g., a wide format printer), a multifunction printer, a desktop printer, an industrial or production printer, a 3D printer, etc. Generally, jetting apparatus 100 includes a mount mechanism 102 that supports one or more printheads 104 in relation to a medium 112. Mount mechanism 102 may be fixed within jetting apparatus 100 for single-pass printing. Alternatively, mount mechanism 102 may be disposed on a carriage assembly that reciprocates back and forth along a scan line or sub-scan direction for multi-pass printing. A printhead 104 is a device, apparatus, or component configured to eject droplets 106 of a print liquid, such as ink (e.g., water-based, solvent-based, oil-based, UV-curable, etc.), through a plurality of nozzles (not visible in FIG. 1). The droplets 106 ejected from the nozzles of printheads 104 are directed toward medium 112. Medium 112 comprises any type of material upon which ink or another print liquid is applied by a printhead, such as paper, plastic, card stock, transparent sheets, a substrate for 3D printing, cloth, etc. Typically, nozzles of printheads 104 are arranged in one or more rows so that ejection of a print liquid from the nozzles causes formation of characters, symbols, images, layers of an object, etc., on medium 112 as printhead 104 and/or medium 112 are moved relative to one another. Jetting apparatus 100 may include a media transport mechanism 114 or a media holding bed 116. Media transport mechanism 114 is configured to move medium 112 relative to printheads 104. Media holding bed 116 (e.g., a platen) is configured to support medium 112 in a stationary position while the printheads 104 move in relation to medium 112.

Jetting apparatus 100 also includes a jetting apparatus controller 122 that controls the overall operation of jetting apparatus 100. Jetting apparatus controller 122 may connect to a data source to receive a print job, print data, image data, or the like, and control each printhead 104 to discharge the print liquid onto medium 112. Jetting apparatus 100 also includes one or more reservoirs 124 for a print liquid or multiple types of print liquid. Although not shown in FIG. 1, reservoirs 124 are fluidly coupled to printheads 104, such as with hoses or the like.

FIG. 2 is a perspective view of a printhead 104 in an illustrative embodiment. FIG. 2 is not drawn to scale. In this embodiment, printhead 104 includes a head member 202 and electronics 204. Head member 202 is an elongated component that forms the jetting channels of printhead 104. A typical jetting channel includes a nozzle, a pressure chamber, and a diaphragm that is driven by an actuator, such as a piezoelectric actuator. Electronics 204 control how the nozzles of printhead 104 jet droplets 106 in response to data signals and control signals received from another controller (e.g., jetting apparatus controller 122). Electronics 204 include an embedded printhead controller 206 or driver circuits configured to drive individual jetting channels based on the data signals and control signals. The bottom surface of head member 202 in FIG. 2 includes the nozzles of the jetting channels, and represents the discharge surface 220 of printhead 104. The top surface of head member 202 in FIG. 2 (referred to as I/O surface 222) represents the Input/Output (I/O) portion for receiving one or more print liquids into printhead 104, and/or conveying print liquids (e.g., print liquid not jetted) out of printhead 104. I/O surface 222 includes a plurality of I/O ports 211-214. An I/O port 211-214 may comprise an inlet I/O port, which is an opening in head member 202 that acts as an inlet or entry point for a print liquid. An I/O port 211-214 may comprise an outlet I/O port, which is an opening in head member 202 that acts as an outlet or exit point for a print liquid. I/O ports 211-214 may include a hose coupling, hose barb, etc., for coupling with a hose of a reservoir, a cartridge, or the like. The number of I/O ports 211-214 is provided as an example, as printhead 104 may include more or less I/O ports in other examples.

In general, head member 202 includes a housing 230 and a plate stack 232. Housing 230 is a rigid member made from stainless steel or another type of material. Housing 230 includes an access hole 234 that provides a passageway for electronics 204 to pass through housing 230 so that actuators may interface with (i.e., come into contact with) diaphragms of the jetting channels. Plate stack 232 attaches to an interface surface (not visible) of housing 230. Plate stack 232 (also referred to as a laminate plate stack) is a series of plates that are fixed or bonded to one another to form a laminated stack. Plate stack 232 may include the following plates: one or more nozzle plates, one or more chamber plates, one or more restrictor plates, a support (or spacer) plate, and a diaphragm plate, although other plates are considered herein, such as a filter plate. A nozzle plate includes a plurality of nozzles that are arranged in one or more rows. A chamber plate includes a plurality of openings that form the pressure chambers of the jetting channels. A restrictor plate includes a plurality of openings that form restrictors (also referred to as channel fluid passages) to fluidly couple the pressure chambers of the jetting channels with a common manifold. A diaphragm plate is a sheet of a semi-flexible material that vibrates in response to actuation by an actuator (e.g., piezoelectric actuator). FIG. 2 illustrates one particular configuration of a printhead 104, and it is understood that other printhead configurations are considered herein that have a plurality of jetting channels. One technical benefit of forming print head with plate stacks is creating combinations of printhead structures in a small space.

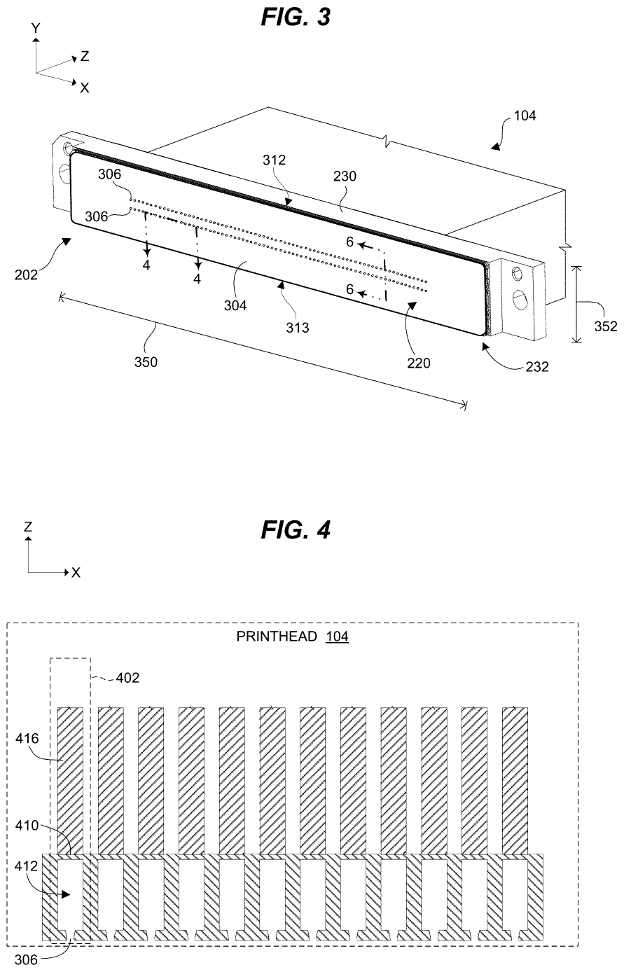

FIG. 3 is a perspective view of a printhead 104 in an illustrative embodiment. FIG. 3 is not drawn to scale. In an embodiment, head member 202 is an assembly of structural elements including housing 230, and plate stack 232 affixed or bonded to housing 230. Plate stack 232 is an elongated stack having a length 350 (i.e., along the x-axis) and a width 352 (i.e., along the y-axis). For this description, the x-axis is along the length 350 of the printhead 104, and may be referred to as the x-direction, lengthwise direction, longitudinal direction, etc. The y-axis is along the width 352 of the printhead 104, and may be referred to as the y-direction, widthwise direction, transverse direction, etc. The z-axis is along the height of the printhead 104, and may be referred to as the z-direction, height direction, etc. Plate stack 232 includes one or more nozzle plates 304 that form nozzles 306 of the jetting channels. Thus, the bottom surface of nozzle plate 304 defines the discharge surface 220 of printhead 104. Nozzles 306 are shown in two nozzle rows in FIG. 3 disposed longitudinally along the length 350 of plate stack 232 and generally parallel to longitudinal sides 312-313 of printhead 104/plate stack 232. Although two rows of nozzles 306 are illustrated in FIG. 3, the jetting channels and their corresponding nozzles 306 may be arranged in a single row or more than two rows in other embodiments.

FIG. 4 is a cross-sectional view of a printhead 104 in an illustrative embodiment. FIG. 4 shows a cross-section of a portion of a row of jetting channels 402 along cut-plane 4-4 in FIG. 3. FIG. 4 is not drawn to scale. A jetting channel 402 is a structural element within printhead 104 configured to jet or eject a print liquid. Each jetting channel 402 includes a diaphragm 410, a pressure chamber 412 (also referred to as a Helmholtz chamber), and a nozzle 306. An actuator 416 contacts diaphragm 410 to control jetting from a jetting channel 402. Jetting channels 402 may be formed in rows along the length 350 of printhead 104 (i.e., plate stack 232), and each jetting channel 402 may have a similar configuration as shown in FIG. 4.

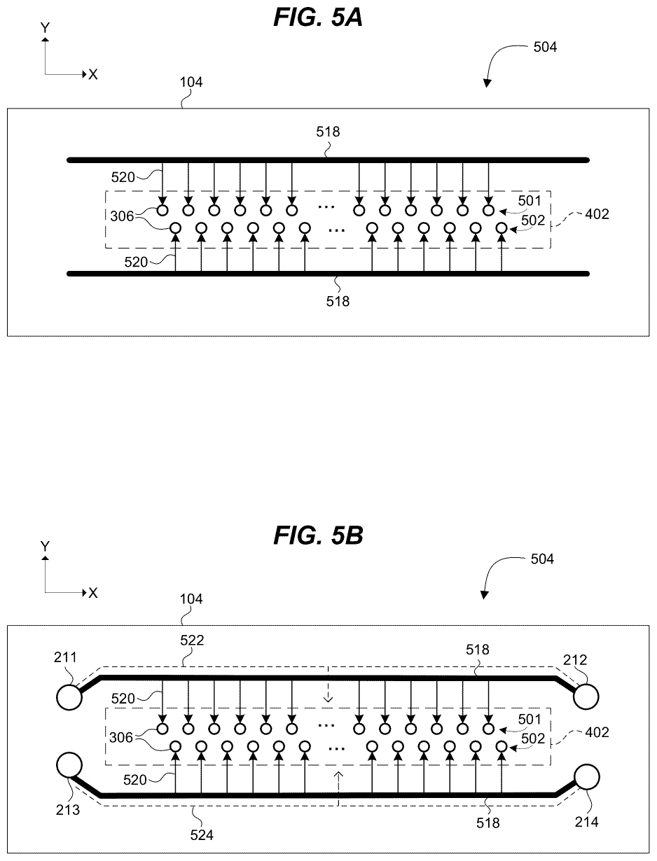

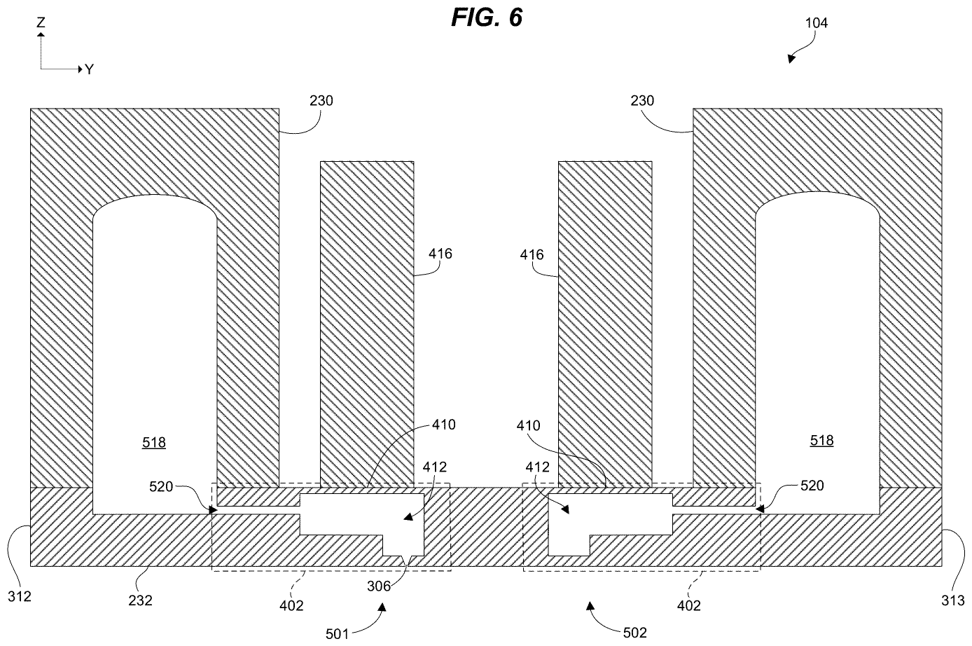

FIG. 5A is a schematic diagram of a printhead 104 in an illustrative embodiment. The jetting channels 402 of printhead 104 are schematically illustrated in FIG. 5A as nozzles 306 in two nozzle rows 501-502. Although the nozzles 306 are shown as staggered in FIG. 5A, the nozzles 306 in the nozzle rows 501-502 may be aligned in other embodiments. Also, although two nozzle rows 501-502 are illustrated in FIG. 5A, printhead 104 may include more or less nozzle rows in other embodiments. Printhead 104 (i.e., head member 202) includes one or more manifolds 518. A manifold 518 is a conduit or channel internal to printhead 104 that provides a common fluid path for a plurality of jetting channels 402, and may be referred to as a common manifold. The major portions or sections of manifolds 518 are disposed longitudinally within printhead 104 to fluidly couple with the jetting channels 402. A plurality of jetting channels 402 are fluidly coupled to a manifold 518 through channel fluid passages 520. A channel fluid passage 520 is a conduit or channel that provides a fluid path between a common manifold and a pressure chamber 412. The size, shape, dimensions, etc., of a channel fluid passage 520 controls a flow of print liquid between a common manifold and a pressure chamber 412, and may be referred to herein as a restrictor. FIG. 5A illustrates a non-flow-through type 504 of printhead 104, where a jetting channel 402 (or more particularly, a pressure chamber 412 of a jetting channel 402) is fluidly coupled to a manifold 518 through a (single) channel fluid passage 520. A manifold 518 may be considered as having a direct fluid coupling with jetting channels 402, as the manifold 518 is fluidly coupled to a jetting channel 402 through a channel fluid passage 520 that controls the flow of the print liquid to/from manifold 518. Although two manifolds 518 are illustrated in FIG. 5A, a printhead 104 may include more or less manifolds as desired.

FIG. 5B is another schematic diagram of a printhead 104 in an illustrative embodiment. In this embodiment, one of the manifolds 518 comprises or defines a fluid path 522 between I/O ports 211-212 and the jetting channels 402 in nozzle row 501. Another one of the manifolds 518 comprises or defines a fluid path 524 between I/O ports 213-214 and the jetting channels 402 in nozzle row 502. FIG. 5B illustrates one example, and a manifold 518 may be fluidly coupled to one I/O port or multiple I/O ports.

FIG. 6 is a cross-sectional view of a non-flow-through type 504 of printhead 104 in an illustrative embodiment. FIG. 6 shows a cross-section of printhead 104 along cut-plane 6-6 in FIG. 3. FIG. 6 is not drawn to scale. Two jetting channels 402 are shown in adjacent rows 501-502. As in FIG. 4, a jetting channel 402 includes diaphragm 410, pressure chamber 412, and nozzle 306 (it is noted that the nozzle 306 of the jetting channel 402 in row 502 is not visible in this cross-section). One of the manifolds 518 (i.e., the lefthand side manifold) of printhead 104 is fluidly coupled to jetting channels 402 of row 501. More particularly, the pressure chamber 412 of a jetting channel 402 in row 501 is fluidly coupled to manifold 518 through a channel fluid passage 520. As described above, the channel fluid passage 520 may comprise a restrictor that controls or regulates a flow of print liquid between manifold 518 and pressure chamber 412. Another one of the manifolds 518 (i.e., the righthand side manifold) of printhead 104 is fluidly coupled to jetting channels 402 of row 502. More particularly, the pressure chamber 412 of a jetting channel 402 in row 502 is fluidly coupled to manifold 518 through a channel fluid passage 520.

When in operation, a print liquid flows from a manifold 518 and into a pressure chamber 412 through a channel fluid passage 520. One wall of the pressure chamber 412 is formed with a diaphragm 410 that physically interfaces with an actuator 416. Diaphragm 410 may comprise a sheet of semi-flexible material that vibrates in response to actuation by actuator 416. To jet from a jetting channel 402, one or more jetting pulses are sent to actuator 416, which actuates or “fires” in response to the jetting pulses. Firing of actuator 416 creates pressure waves in pressure chamber 412 that cause jetting of one or more droplets 106 from nozzle 306.

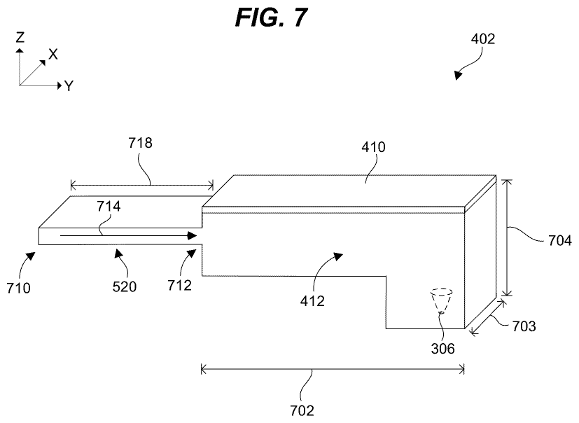

FIG. 7 is a perspective view of a jetting channel 402 in an illustrative embodiment. FIG. 7 is not drawn to scale. As above, jetting channel 402 includes pressure chamber 412, diaphragm 410, and a nozzle 306. Pressure chamber 412 has a length 702 (i.e., along the y-axis), a width 703 (i.e., along the x-axis), and a height 704 (i.e., along the z-axis). Jetting channel 402 also includes a channel fluid passage 520 that fluidly couples the pressure chamber 412 to a manifold 518. The channel fluid passage 520 includes a manifold opening 710 to the manifold 518, and a pressure chamber opening 712 to the pressure chamber 412. In general, the major flow of print liquid enters channel fluid passage 520 from a manifold 518 (not shown) at the manifold opening 710 and flows longitudinally or lengthwise in flow direction 714 (e.g., along the y-axis) along the length 718 of channel fluid passage 520. The print liquid exits the channel fluid passage 520 at the pressure chamber opening 712 and flows into the pressure chamber 412. The print liquid in the pressure chamber 412 may be jetted from nozzle 306 in response to movement or vibration of the diaphragm 410.

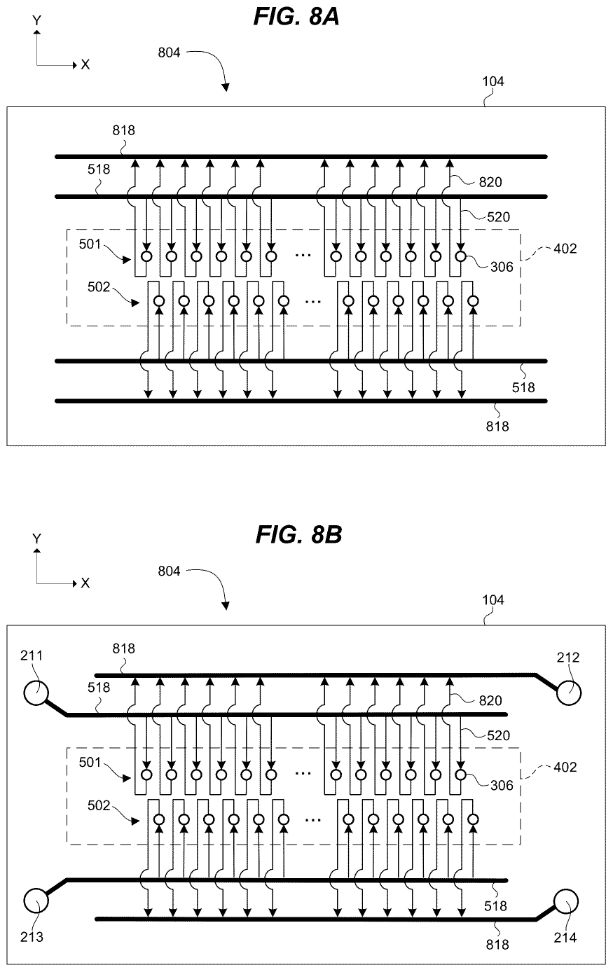

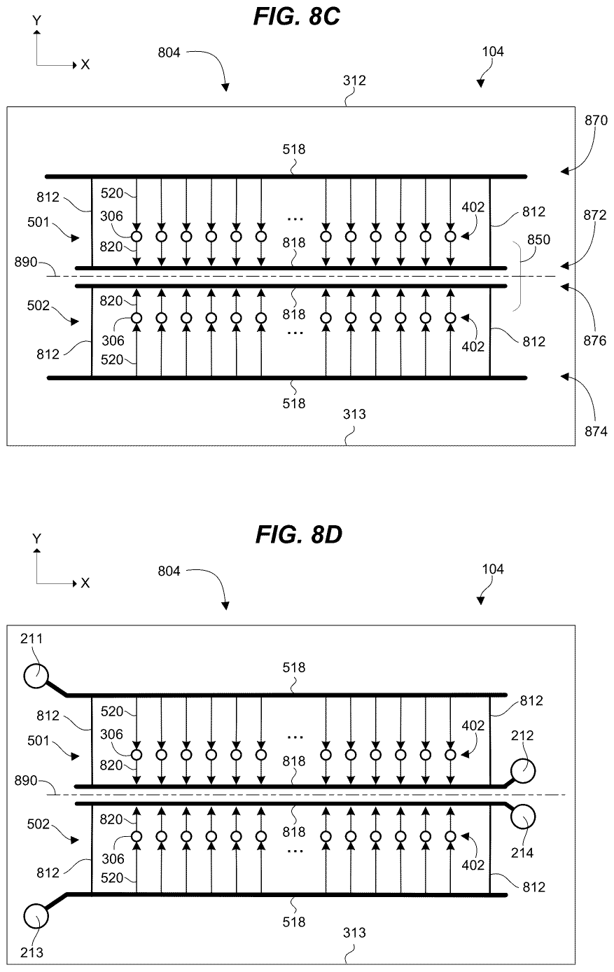

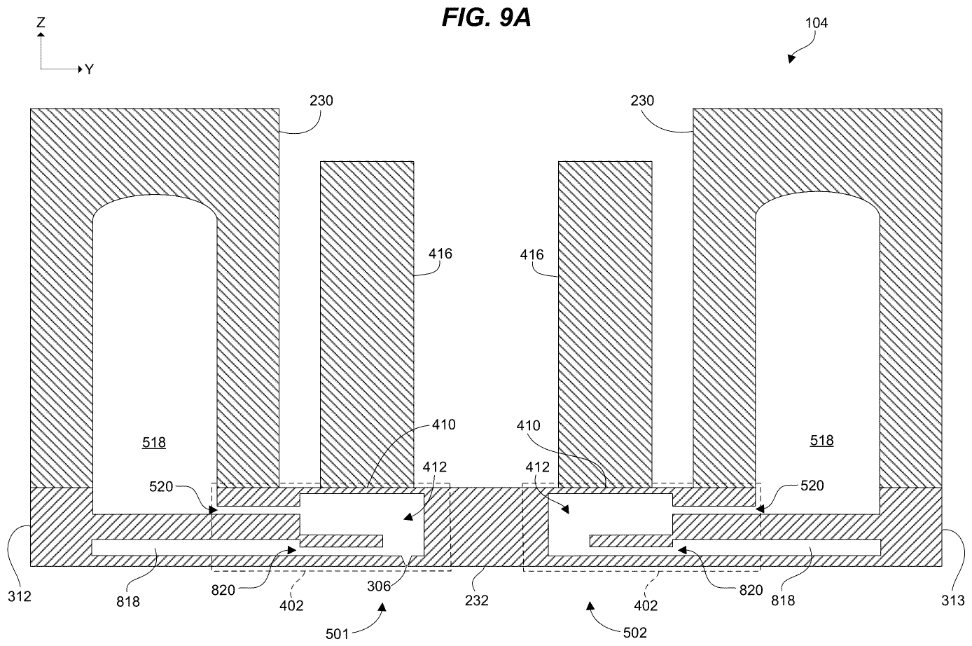

FIG. 8A is a schematic diagram of a printhead 104 in another illustrative embodiment. The jetting channels 402 of printhead 104 are schematically illustrated in FIG. 8A as nozzles 306 in two nozzle rows 501-502. Although the nozzles 306 are shown as staggered in FIG. 8A, the nozzles 306 in the nozzle rows 501-502 may be aligned in other embodiments. Also, although two nozzle rows 501-502 are illustrated in FIG. 8A, printhead 104 may include more or less nozzle rows in other embodiments. Printhead 104 (i.e., head member 202) includes a plurality of manifolds 518 and 818. A plurality of jetting channels 402 are fluidly coupled to manifold 518 and manifold 818 through channel fluid passages 520 and channel fluid passages 820, respectively. FIG. 8A illustrates a flow-through type 804 of printhead 104, where a jetting channel 402 (or more particularly, a pressure chamber 412 of a jetting channel 402) is fluidly coupled to one or more manifolds through a plurality of channel fluid passages. For example, a pressure chamber 412 in FIG. 8A is fluidly coupled to a manifold 518 (which may be referred to as a first common manifold or a supply manifold) through a channel fluid passage 520 (which may be referred to as a first channel fluid passage), and is fluidly coupled to a manifold 818 (which may be referred to as a second common manifold or a return manifold) through a channel fluid passage 820 (which may be referred to as a second channel fluid passage). Although four manifolds 518 and 818 are illustrated in FIG. 8A, a printhead 104 may include more or less manifolds as desired.

Each jetting channel 402, as a flow-through type of jetting channel, has an independent fluid path into a pressure chamber 412 and an independent fluid path out of the pressure chamber 412, which are not shared or common with another jetting channel 402. For example, each jetting channel 402 of row 501 includes a channel fluid passage 520 between manifold 518 and a pressure chamber 412 of the jetting channel 402, and also includes a channel fluid passage 820 between the pressure chamber 412 of the jetting channel 402 and manifold 818. Channel fluid passages 520/820 represent distinct pathways for print fluid to flow, for example, from manifold 518 into a pressure chamber 412, and for (non-jetted) print fluid to flow out of the pressure chamber 412 to manifold 818 (or in the reverse direction).

FIG. 8B is another schematic diagram of a printhead 104 in an illustrative embodiment. In this embodiment, one of the manifolds 518 comprises or defines a fluid path between I/O port 211 and the jetting channels 402 in nozzle row 501, and another of the manifolds 818 comprises or defines a fluid path between I/O port 212 and the jetting channels 402 in nozzle row 501. Another one of the manifolds 518 comprises or defines a fluid path between I/O port 213 and the jetting channels 402 in nozzle row 502, and another of the manifolds 818 comprises or defines a fluid path between I/O port 214 and the jetting channels 402 in nozzle row 502. FIG. 8B illustrates one example, and manifolds 518 and 818 may be fluidly coupled to one I/O port or multiple I/O ports.

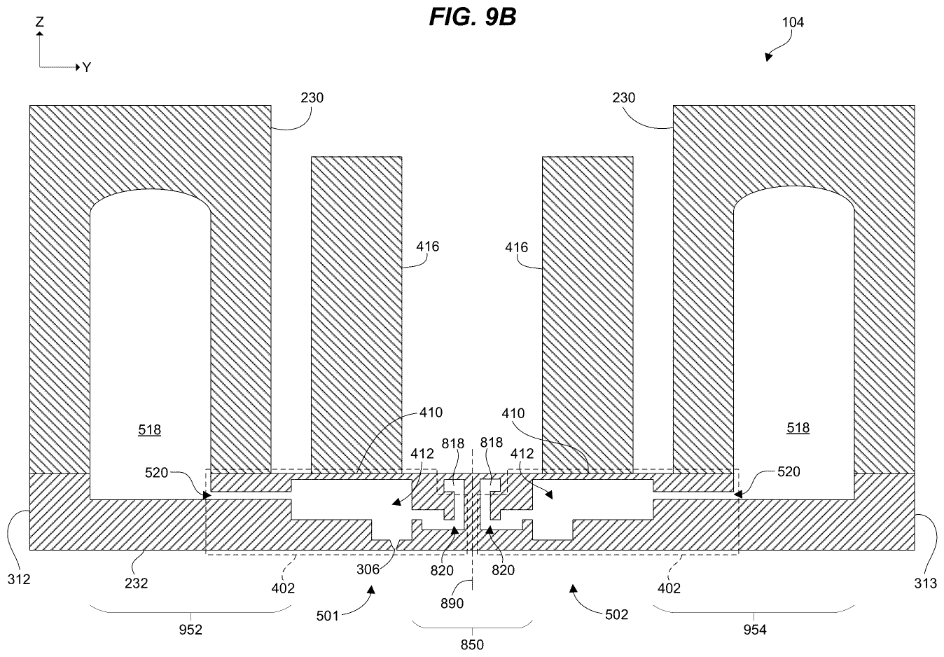

FIG. 9A is a cross-sectional view of a flow-through type 804 of printhead 104 in an illustrative embodiment. FIG. 9A shows a cross-section of printhead 104 along cut-plane 6-6 in FIG. 3, for a flow-through type 804 of printhead 104 as depicted in FIGS. 8A-8B. FIG. 9A is not drawn to scale. Two jetting channels 402 are shown in adjacent rows 501-502. As in FIG. 4, a jetting channel 402 includes diaphragm 410, pressure chamber 412, and nozzle 306 (it is noted that the nozzle 306 of the jetting channel 402 in row 502 is not visible in this cross-section). On the lefthand side, one of the manifolds 518 of printhead 104 is fluidly coupled to jetting channels 402 of row 501. More particularly, the pressure chamber 412 of a jetting channel 402 in row 501 is fluidly coupled to manifold 518 through a channel fluid passage 520. As described above, the channel fluid passage 520 may comprise a restrictor that controls or regulates a flow of print liquid between manifold 518 and pressure chamber 412. On the lefthand side, another one of the manifolds 818 of printhead 104 is also fluidly coupled to jetting channels 402 of row 501. More particularly, the pressure chamber 412 of a jetting channel 402 in row 501 is fluidly coupled to manifold 818 through a channel fluid passage 820. The channel fluid passage 820 may comprise a restrictor that controls or regulates a flow of print liquid between manifold 818 and pressure chamber 412. The righthand side of the printhead 104 has a similar configuration.

When in operation, a print liquid may flow from a manifold 518 and into a pressure chamber 412 through channel fluid passage 520. One wall of the pressure chamber 412 is formed with a diaphragm 410 that physically interfaces with an actuator 416. To jet from a jetting channel 402, one or more jetting pulses are sent to actuator 416, which actuates or “fires” in response to the jetting pulses. Firing of actuator 416 creates pressure waves in pressure chamber 412 that cause jetting of one or more droplets 106 from nozzle 306. Non-jetted print liquid may flow from the pressure chamber 412 and into a manifold 818 through channel fluid passage 820. Thus, a print liquid may flow through the jetting channel 402 from one manifold 518 to another manifold 818. It is noted that the flow of print liquid may be reversed in jetting channels 402, such as when the structures of channel fluid passages 520/820 are substantially similar.

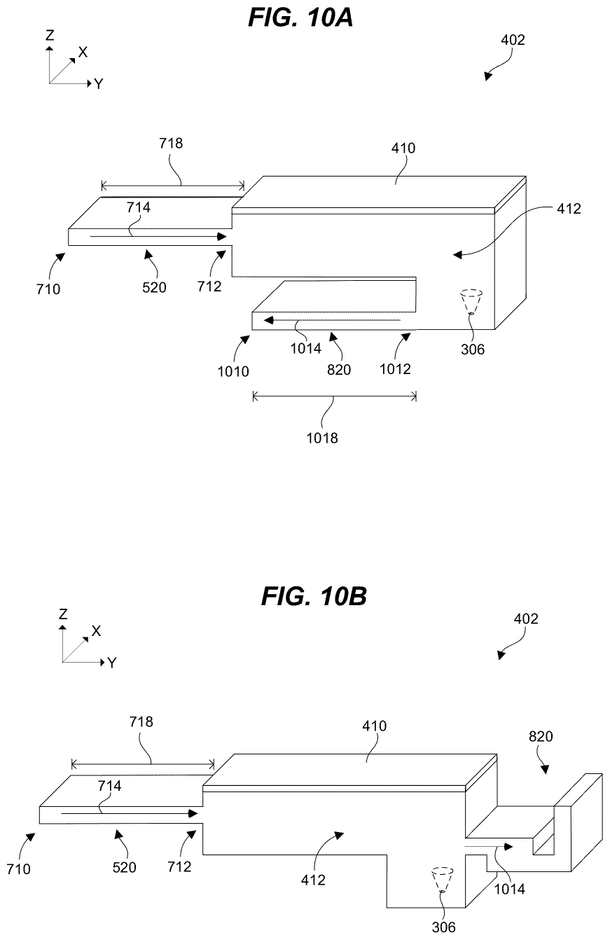

FIG. 10A is a perspective view of a jetting channel 402 in an illustrative embodiment, such as for a flow-through type 804 of printhead 104 as depicted in FIGS. 8A-8B and 9A. FIG. 10A is not drawn to scale. As above, jetting channel 402 includes pressure chamber 412, diaphragm 410, and a nozzle 306. Jetting channel 402 also includes channel fluid passage 520 and channel fluid passage 820. The channel fluid passage 520 fluidly couples the pressure chamber 412 to a manifold 518. The channel fluid passage 520 includes a manifold opening 710 to the manifold 518, and a pressure chamber opening 712 to the pressure chamber 412. The channel fluid passage 820 fluidly couples the jetting channel 402 to a manifold 818. The channel fluid passage 820 includes a manifold opening 1010 to the manifold 818, and a pressure chamber opening 1012 to the pressure chamber 412. In general, the major flow of print liquid enters channel fluid passage 520 from a manifold 518 (not shown) at the manifold opening 710 and flows longitudinally or lengthwise in flow direction 714 (e.g., along the y-axis) along the length 718 of channel fluid passage 520. The print liquid exits the channel fluid passage 520 at the pressure chamber opening 712 and flows into the pressure chamber 412. The print liquid in the pressure chamber 412 may be jetted from nozzle 306 in response to movement or vibration of the diaphragm 410. Non-jetted print liquid enters channel fluid passage 820 from the pressure chamber 412 at the pressure chamber opening 1012 and flows longitudinally or lengthwise in flow direction 1014 (e.g., along the y-axis) along the length 1018 of channel fluid passage 820. The print liquid exits the channel fluid passage 820 at the manifold opening 1010 and flows into a manifold 818. It is noted again that the flow of print liquid may be reversed through a jetting channel 402.

FIG. 8C is a schematic diagram of a printhead 104 in another illustrative embodiment. The jetting channels 402 of printhead 104 are schematically illustrated in FIG. 8C as nozzles 306 in two nozzle rows 501-502. Although the nozzles 306 are shown as staggered in FIG. 8C, the nozzles 306 in the nozzle rows 501-502 may be aligned in other embodiments. Also, although two nozzle rows 501-502 are illustrated in FIG. 8C, printhead 104 may include more or less nozzle rows in other embodiments. Printhead 104 (i.e., head member 202) includes a plurality of manifolds 518 and 818. A plurality of jetting channels 402 are fluidly coupled to manifold 518 and manifold 818 through channel fluid passages 520 and channel fluid passages 820, respectively. FIG. 8C illustrates a flow-through type 804 of printhead 104, where a jetting channel 402 (or more particularly, a pressure chamber 412 of a jetting channel 402) is fluidly coupled to one or more manifolds through a plurality of channel fluid passages 520/820. For each row, manifold 518 is fluidly coupled with manifold 818 through the jetting channels 402, and may also be fluidly coupled with manifold 818 through one or more inter-manifold fluid passages 812.

The major portions or sections of manifolds 518 and 818 are disposed longitudinally (i.e., along the x-axis) within printhead 104 to fluidly couple with jetting channels 402 arranged in a row 501-502. In some flow-through printheads, both manifolds 518/818 are disposed longitudinally on the same side of a row of jetting channels, such as shown in FIGS. 8A-8B. In an embodiment herein, manifolds 518/818 are disposed on opposite sides of a row of jetting channels 402. To illustrate this structure, longitudinal sides 312-313 of printhead 104 are shown. A manifold 518 is disposed on one side 870 (i.e., a first side) of the row 501 of jetting channels 402 between longitudinal side 312 and row 501, and a manifold 818 is disposed on the other side 872 (i.e., a second side) of the row 501 of jetting channels 402 between adjacent rows 501-502 (i.e., between row 501 and the longitudinal centerline 890 of the printhead 104). A “side” of a row of jetting channels 402 comprises a longitudinal side along the length of the row. A manifold 818 is disposed in an intermediate region 850 between the rows 501-502 of jetting channels 402 as are the channel fluid passages 820 of the individual jetting channels 402 in row 501. Likewise, a manifold 518 is disposed on one side 874 (i.e., a first side) of the row 502 of jetting channels 402 between longitudinal side 313 and the row 502, and a manifold 818 is disposed on the other side 876 (i.e., a second side) of the row 502 of jetting channels 402 between adjacent rows 501-502 (i.e., between row 502 and the longitudinal centerline 890). Manifold 818 is disposed in intermediate region 850 between the rows 501-502 as are the channel fluid passages 820 of the individual jetting channels 402 in row 502.

FIG. 8D is another schematic diagram of a printhead 104 in an illustrative embodiment. In this embodiment, one of the manifolds 518 comprises or defines a fluid path between I/O port 211 and the jetting channels 402 in nozzle row 501, and another of the manifolds 818 comprises or defines a fluid path between I/O port 212 and the jetting channels 402 in nozzle row 501. Another one of the manifolds 518 comprises or defines a fluid path between I/O port 213 and the jetting channels 402 in nozzle row 502, and another of the manifolds 818 comprises or defines a fluid path between I/O port 214 and the jetting channels 402 in nozzle row 502. FIG. 8D illustrates one example, and manifolds 518 and 818 may be fluidly coupled to one I/O port or multiple I/O ports.

FIG. 9B is a cross-sectional view of a flow-through type 804 of printhead 104 in an illustrative embodiment. FIG. 9B shows a cross-section of printhead 104 along cut-plane 6-6 in FIG. 3, for a flow-through type 804 of printhead 104 as depicted in FIGS. 8C-8D. FIG. 9B is not drawn to scale. Two jetting channels 402 are shown in adjacent rows 501-502. As in FIG. 4, a jetting channel 402 includes diaphragm 410, pressure chamber 412, and nozzle 306 (it is noted that the nozzle 306 of the jetting channel 402 in row 502 is not visible in this cross-section). On the lefthand side, one of the manifolds 518 of printhead 104 is fluidly coupled to jetting channels 402 of row 501. More particularly, the pressure chamber 412 of a jetting channel 402 in row 501 is fluidly coupled to manifold 518 through a channel fluid passage 520. As described above, the channel fluid passage 520 may comprise a restrictor that controls or regulates a flow of print liquid between manifold 518 and pressure chamber 412. On the lefthand side, another one of the manifolds 818 of printhead 104 is also fluidly coupled to jetting channels 402 of row 501. More particularly, the pressure chamber 412 of a jetting channel 402 in row 501 is fluidly coupled to manifold 818 through a channel fluid passage 820. The righthand side of the printhead 104 has a similar configuration for row 502.

Row 501 of jetting channels 402 and row 502 of jetting channels 402 are adjacent to one another within printhead 104, and are separated by a longitudinal centerline 890. Manifolds 818 are disposed in an intermediate region 850 of printhead 104/plate stack 232 between the rows 501-502 of jetting channels 402. More particularly, manifolds 818 are disposed between pressure chambers 412 of jetting channels 402 in adjacent rows 501-502. For a jetting channel 402 in row 501, manifold 518 is disposed on one side of pressure chamber 412 (along the y-axis) in an outer region 952 of printhead 104/plate stack 232 between the row 501 of jetting channels 402 and a longitudinal side 312. Manifold 518 is fluidly coupled to the pressure chamber 412 via channel fluid passage 520 that is also disposed in outer region 952. Manifold 818 is disposed on the other side of the pressure chamber 412 (in relation to manifold 518) along the y-axis in the intermediate region 850. Manifold 818 is disposed between the pressure chamber 412 and the longitudinal centerline 890. For a jetting channel 402 in row 502, manifold 518 is disposed on one side of pressure chamber 412 (along the y-axis) in an outer region 954 of printhead 104/plate stack 232 between the row 502 of jetting channels 402 and a longitudinal side 313. Manifold 518 is fluidly coupled to the pressure chamber 412 via channel fluid passage 520 that is also disposed in outer region 954. Manifold 818 is disposed on the other side of the pressure chamber 412 (in relation to manifold 518) along the y-axis in the intermediate region 850. Manifold 818 is disposed between the pressure chamber 412 and the longitudinal centerline 890.

FIG. 10B is a perspective view of a jetting channel 402 in an illustrative embodiment, such as for a flow-through type 804 of printhead 104 as depicted in FIGS. 8C-8D and 9B. FIG. 10B is not drawn to scale. As above, jetting channel 402 includes pressure chamber 412, diaphragm 410, and a nozzle 306. Jetting channel 402 also includes channel fluid passage 520 and channel fluid passage 820. The channel fluid passage 520 fluidly couples the pressure chamber 412 to a manifold 518. The channel fluid passage 520 includes a manifold opening 710 to the manifold 518, and a pressure chamber opening 712 to the pressure chamber 412. The channel fluid passage 820 fluidly couples the jetting channel 402 to a manifold 818. In general, the major flow of print liquid enters channel fluid passage 520 from a manifold 518 (not shown) at the manifold opening 710 and flows longitudinally or lengthwise in flow direction 714 (e.g., along the y-axis) along the length 718 of channel fluid passage 520. The print liquid exits the channel fluid passage 520 at the pressure chamber opening 712 and flows into the pressure chamber 412. The print liquid in the pressure chamber 412 may be jetted from nozzle 306 in response to movement or vibration of the diaphragm 410. Non-jetted print liquid flows out of the opposite side of pressure chamber 412 through channel fluid passage 820. Thus, the print fluid flows into and out of pressure chamber 412 via channel fluid passage 520 and channel fluid passage 820 in a same lengthwise direction (i.e., along the y-axis) of the jetting channel 402. In this structure, channel fluid passage 520 and channel fluid passage 820 are disposed on opposite sides of the pressure chamber 412 in the lengthwise direction. It is noted again that the flow direction may be reversed in other embodiments.

A jetting channel 402 as shown in the above figures are examples to illustrate a basic structure of a jetting channel, such as the diaphragm, pressure chamber, nozzle, and channel fluid passages. Other types of jetting channels are also considered herein. For example, some jetting channels may have a pressure chamber having a different shape than is illustrated above.

One potential issue that may affect jetting from a jetting channel 402 is backflow of print liquid out of a pressure chamber 412, such as into a channel fluid passage(s). When this occurs, the printhead energy (i.e., pressure waves) generated within a pressure chamber 412 for droplet ejection is dissipated. Thus, higher voltages may be needed for droplet ejection.

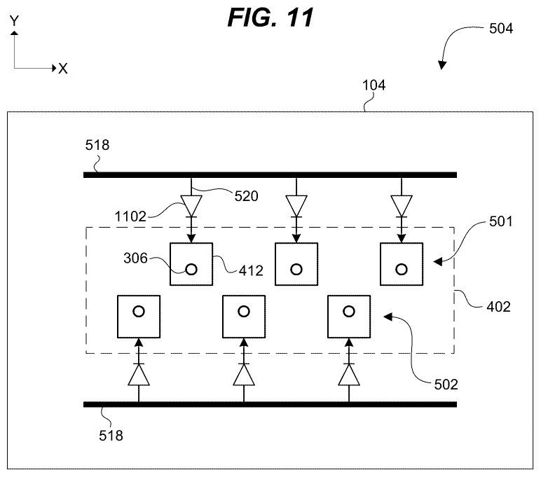

In embodiments described herein, passive valves may be used or implemented within jetting channels 402 to reduce or minimize backflow of print liquid. FIG. 11 is a schematic diagram of a non-flow-through type 504 of printhead 104 in an illustrative embodiment. FIG. 11 is a magnified view of a plurality of jetting channels 402 schematically illustrated as pressure chambers 412 and nozzles 306 in two nozzle rows 501-502. As in FIG. 5A, for example, a jetting channel 402 (or more particularly, a pressure chamber 412 of a jetting channel 402) is fluidly coupled to a manifold 518 through a (single) channel fluid passage 520. In an embodiment, a passive valve 1102 is disposed in the channel fluid passage 520 of a jetting channel 402 between a manifold 518 and the pressure chamber 412. A passive valve 1102 is a structural device or element that regulates, directs, or controls a direction of flow of a liquid. A passive valve 1102 is considered “passive” by comprising a fixed-geometry that provides the function of a valve, as opposed to moving parts such as a shutter or flapper type of valve. A passive valve 1102 as described herein may be considered a one-way valve or a unidirectional valve that normally allows liquid to flow in (e.g., only) one direction. As used herein, an ideal one-way value or unidirectional valve allows flow in the normal flow direction and no flow in the opposite direction (a backflow direction). Although a passive valve 1102 as described herein may not operate as an ideal one-way or unidirectional valve, a passive valve 1102 at a macro scale, favors or supports flow in one direction to a degree that resembles a one-way valve or a unidirectional valve. As used herein, effectiveness of a one-way valve refers to its ability to perform in alignment with the characteristics of an ideal one-way valve. When a passive valve 1102 is disposed in the channel fluid passage 520 of a jetting channel 402 as in FIG. 11, the passive valve 1102 is configured to inhibit a flow (e.g., a back flow) of print liquid from the pressure chamber 412 towards a manifold 518. Although a limited number of jetting channels 402 are illustrated in FIG. 11, a passive valve 1102 may be implemented in the channel fluid passage 520 of each jetting channel 402 of a printhead 104. One technical benefit of this embodiment is that the passive valves 1102 of the jetting channels 402 restrict or confine applied energy from an actuator to the pressure chambers 412.

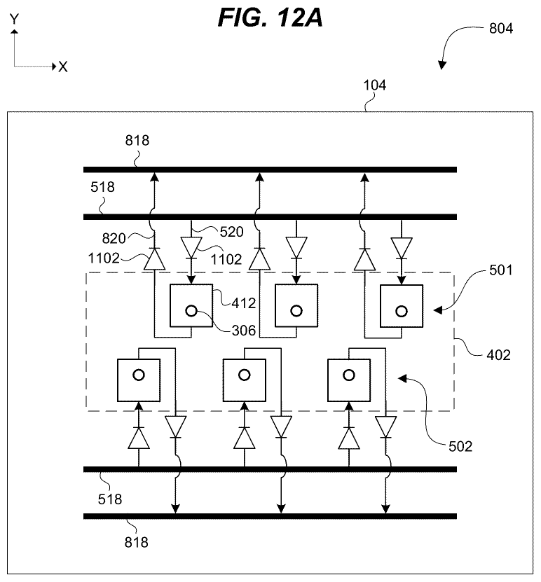

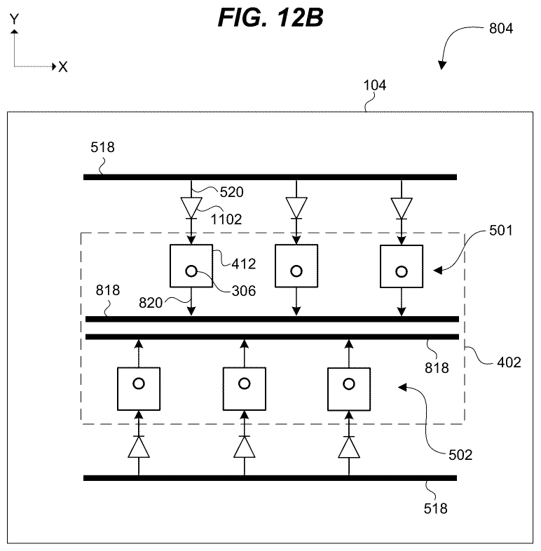

FIG. 12A is a schematic diagram of a flow-through type 804 of printhead 104 in an illustrative embodiment. FIG. 12A is a magnified view of a plurality of jetting channels 402 schematically illustrated as pressure chambers 412 and nozzles 306 in two nozzle rows 501-502. As in FIG. 8A, for example, a jetting channel 402 (or more particularly, a pressure chamber 412 of a jetting channel 402) is fluidly coupled to a manifold 518 through a (first) channel fluid passage 520, and is fluidly coupled to a manifold 818 through a (second) channel fluid passage 820. In an embodiment, a passive valve 1102 (e.g., a first passive valve) may be disposed in the channel fluid passage 520 of a jetting channel 402 between a manifold 518 and the pressure chamber 412, and/or a passive valve 1102 (e.g., a second passive valve) may disposed in the channel fluid passage 820 of the jetting channel 402 between a manifold 818 and the pressure chamber 412. When a passive valve 1102 is disposed in the channel fluid passage 520 of a jetting channel 402 as in FIG. 12A, the passive valve 1102 is configured to inhibit a flow (i.e., back flow) of print liquid from the pressure chamber 412 towards a manifold 518. Similarly, when a passive valve 1102 is disposed in the channel fluid passage 820 of a jetting channel 402, the passive valve 1102 is configured to inhibit a flow of print liquid from the manifold 818 towards the pressure chamber 412. Although a limited number of jetting channels 402 are illustrated in FIG. 12A, a passive valve 1102 may be implemented in channel fluid passages 520 and/or channel fluid passages 820 of each jetting channel 402 of a printhead 104. One technical benefit of this embodiment is that the passive valves 1104 of the jetting channels 402 restrict or confine applied energy from an actuator to the pressure chambers 412.

FIG. 12B is a schematic diagram of a flow-through type 804 of printhead 104 in an illustrative embodiment. FIG. 12B is a magnified view of a plurality of jetting channels 402 schematically illustrated as pressure chambers 412 and nozzles 306 in two nozzle rows 501-502. As in FIG. 8C, for example, a jetting channel 402 (or more particularly, a pressure chamber 412 of a jetting channel 402) is fluidly coupled to a manifold 518 through a (first) channel fluid passage 520, and is fluidly coupled to a manifold 818 through a (second) channel fluid passage 820. In an embodiment, a passive valve 1102 may be disposed in the channel fluid passage 520 of a jetting channel 402 between a manifold 518 and the pressure chamber 412. When a passive valve 1102 is disposed in the channel fluid passage 520 of a jetting channel 402 as in FIG. 12B, the passive valve 1102 is configured to inhibit a flow (i.e., back flow) of print liquid from the pressure chamber 412 towards a manifold 518. Although a limited number of jetting channels 402 are illustrated in FIG. 12B, a passive valve 1102 may be implemented in the channel fluid passage 520 of each jetting channel 402 of a printhead 104. Although not shown in FIG. 12B, a passive valve 1102 may be disposed in the channel fluid passage 820 of a jetting channel 402 between the pressure chamber 412 and a manifold 818. When a passive valve 1102 is disposed in the channel fluid passage 820 of a jetting channel 402, the passive valve 1102 is configured to inhibit a flow (i.e., back flow) of print liquid from the manifold 818 towards the pressure chamber 412. One technical benefit of this embodiment is that the passive valves 1104 of the jetting channels 402 restrict or confine applied energy from an actuator to the pressure chambers 412.

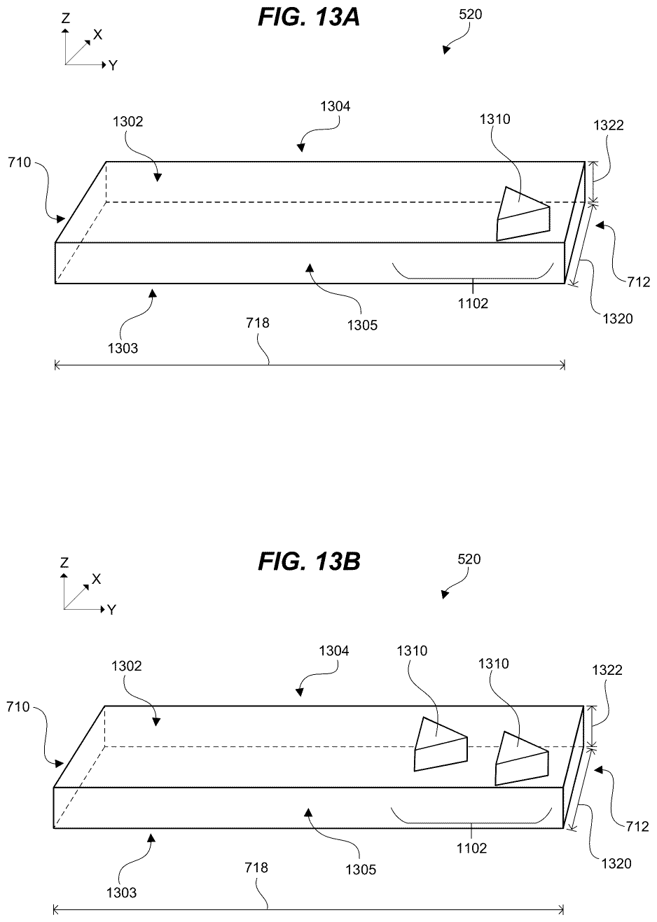

FIGS. 13A-13B are perspective views of a channel fluid passage 520 with a passive valve 1102 in illustrative embodiments. FIGS. 13A-13B are not drawn to scale. In general, a channel fluid passage 520 is a rectangular and hollow channel, conduit, or duct configured to convey a print liquid. A channel fluid passage 520 has dimensions of a length 718 in the y-direction, a width 1320 in the x-direction, and a height 1322 in the z-direction. The channel fluid passage 520 is defined by a top wall 1302 and an opposing bottom wall 1303. Top wall 1302 and bottom wall 1303 may comprise generally flat or planar surfaces disposed horizontally or generally parallel to a discharge surface 220 of the printhead 104. Top wall 1302 and bottom wall 1303 are separated by a distance in the z-direction that defines the height 1322 of the channel fluid passage 520. The channel fluid passage 520 is further defined by opposing side walls 1304-1305. Side walls 1304-1305 may comprise generally flat or planar surfaces disposed vertically or generally transverse to the top wall 1302 and bottom wall 1303, and transverse to the discharge surface 220 of the printhead 104. Side walls 1304-1305 are separated by a distance in the x-direction that defines the width 1320 of the channel fluid passage 520. One technical benefit for the noted walls is the effectiveness of a passive valve 1102 may be improved.

A passive valve 1102 may be disposed or formed within a channel fluid passage 520. The “body” or “casing” of a passive valve 1102 is defined by at least a portion of the top wall 1302, bottom wall 1303, and opposing side walls 1304-1305 of the channel fluid passage 520. The passive valve 1102 comprises one or more fixed valve members 1310 disposed between the opposing side walls 1304-1305 of the channel fluid passage 520. A fixed valve member 1310 is a motionless or stationary structural element that projects into channel fluid passage 520, and at least partially obstructs a flow of liquid through channel fluid passage 520. As in FIG. 13A, a passive valve 1102 may comprise a single fixed valve member 1310. As in FIG. 13B, a passive valve 1102 may comprise a plurality of fixed valve members 1310.

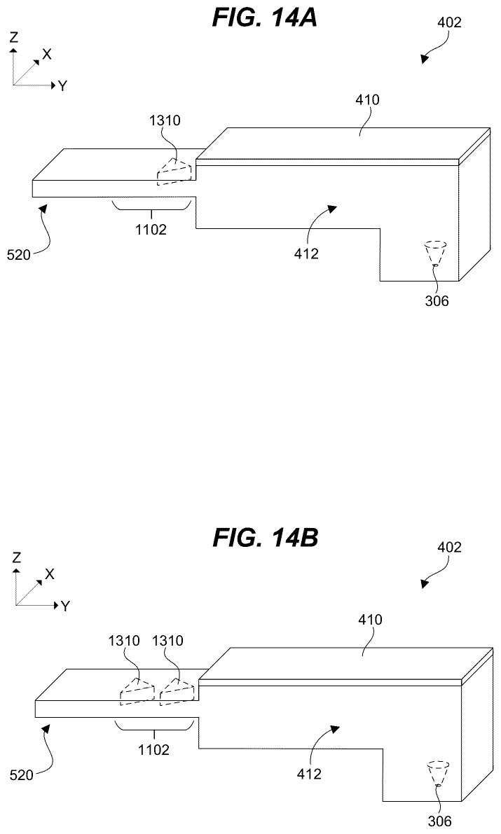

FIGS. 14A-14B are perspective views of a jetting channel 402 in illustrative embodiments. FIGS. 14A-14B are not drawn to scale. In FIG. 14A, a passive valve 1102 comprising a single fixed valve member 1310 is disposed or formed within the channel fluid passage 520 of the jetting channel 402. In FIG. 14B, a passive valve 1102 comprising a plurality of fixed valve members 1310 is disposed or formed within the channel fluid passage 520 of the jetting channel 402.

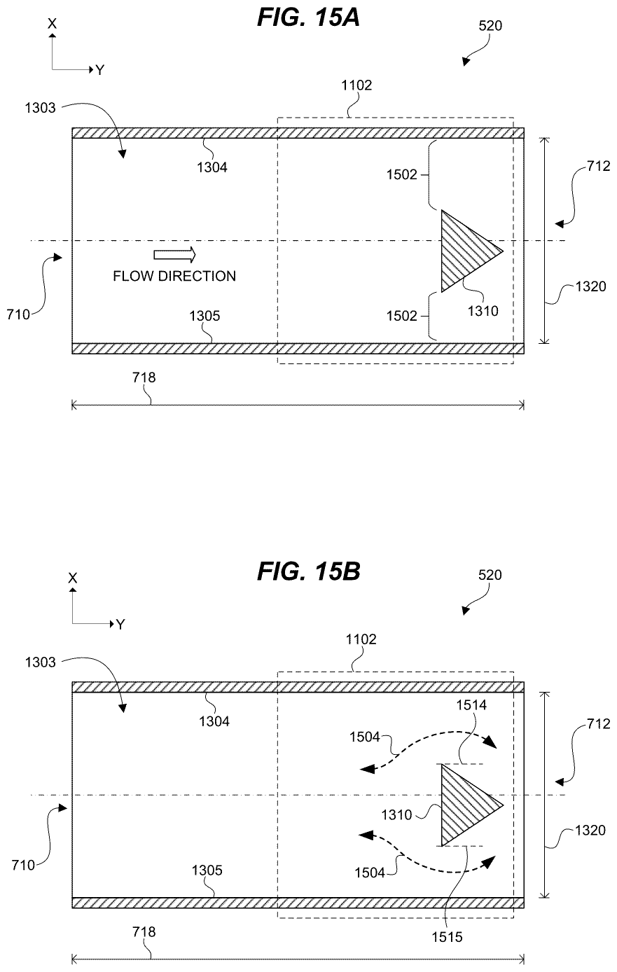

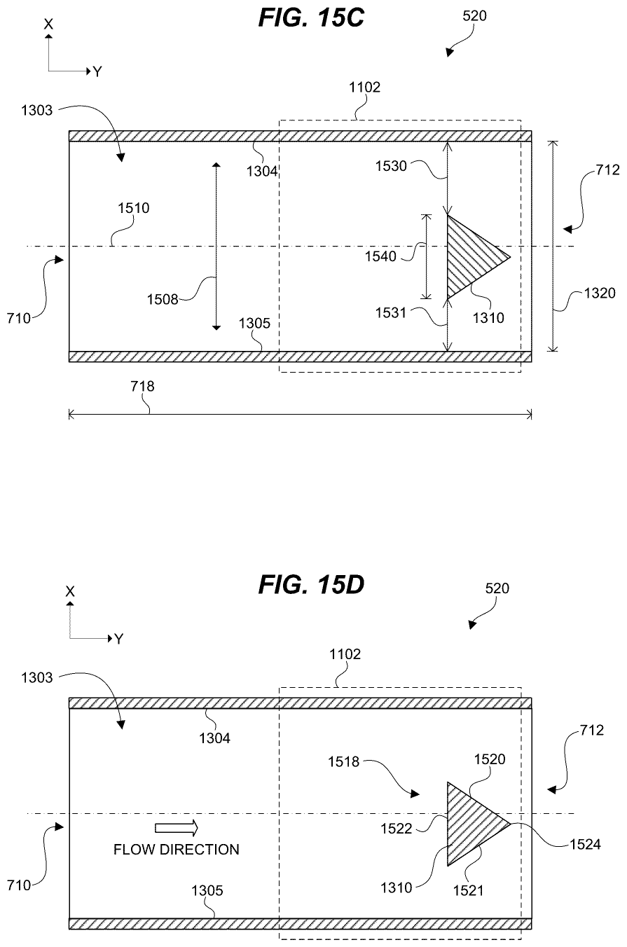

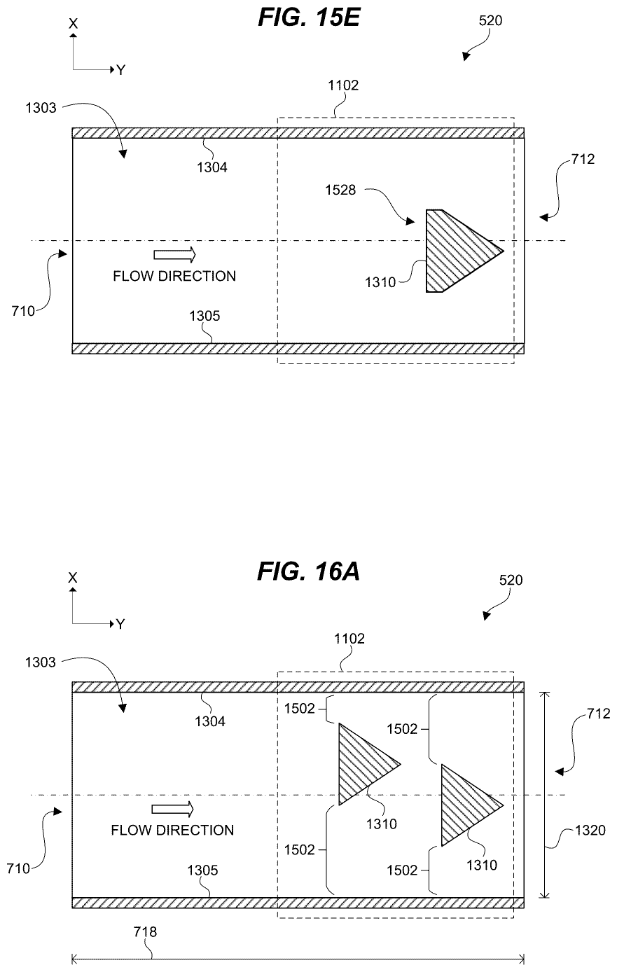

FIGS. 15A-15E are cross-sectional views of a channel fluid passage 520 in illustrative embodiments. The views in FIG. 15A-15E are of a cross-section taken along an x-y cut plane. FIGS. 15A-15E are not drawn to scale. In FIG. 15A, the passive valve 1102 formed in the channel fluid passage 520 comprises a fixed valve member 1310 disposed between opposing side walls 1304-1305 across the width 1320 of the channel fluid passage 520. The fixed valve member 1310 projects into channel fluid passage 520, and at least partially obstructs a flow of liquid through channel fluid passage 520. For example, fixed valve member 1310 may project from a top wall 1302 of channel fluid passage 520, may project from a bottom wall 1303 of channel fluid passage 520, etc. There are physical separations 1502 or gaps between the fixed valve member 1310 and the side walls 1304-1305 of the channel fluid passage 520. In FIG. 15B, the physical separations 1502 are configured to form flow paths 1504 on opposing sides 1514-1515 of the fixed valve member 1310. Thus, a flow of print liquid in either direction along the length 718 of the channel fluid passage 520 will be divided along separate flow paths 1504. One technical benefit is the fixed valve member 1310 of the passive valve 1102 disturbs or divides a flow of print liquid into a pressure chamber 412 (i.e., in the normal flow direction, such as flow direction 714 in FIG. 7), which acts to mix the print liquid as it enters the pressure chamber 412. Another technical benefit is the passive valve 1102 inhibits a flow of print liquid (e.g., a back flow) in the opposite direction out of the pressure chamber 412. Thus, the passive valve 1102 acts as a unidirectional valve that restricts or confines applied energy (e.g., pressure waves) to the pressure chamber, which improves jetting efficiency.

In an embodiment, the positioning of a fixed valve member 1310 may be asymmetric with respect to the side walls 1304-1305 in a widthwise direction 1508, as in FIG. 15C. Thus, the fixed valve member 1310 may be offset from a longitudinal centerline 1510 of the channel fluid passage 520 in the widthwise direction 1508. One technical benefit is the effectiveness of a passive valve 1102 may be improved. Although the dimensions and/or positioning of the fixed valve member 1310 may vary, the fixed valve member 1310 may be offset from the longitudinal centerline 1510 by a distance in a range of about 0.05 to 0.15 times the width 1320 of the channel fluid passage 520. The fixed valve member 1310 is separated from one of the side walls 1304 (e.g., a first side wall) by a first distance 1530 in the widthwise direction 1508, and is separated from the other of the side walls 1305 (e.g., a second side wall) by a second distance 1531 in the widthwise direction 1508 (the first distance 1530 and the second distance 1531 are different). Thus, the fixed valve member 1310 is disposed closer to one of the side walls 1304 than the other of the side walls 1305. In an embodiment, the width 1540 (i.e., maximum width) of the fixed valve member 1310 may be in a range of about 0.4 to 0.6 times the width 1320 of the channel fluid passage 520. Any combination of these dimensions and/or positioning of the fixed valve member 1310 may provide a technical benefit of improving the effectiveness of a passive valve 1102.

In an embodiment, a cross-section of the fixed valve member 1310 has a generally triangular shape 1518, as illustrated in FIG. 15D and the above figures. For example, the triangular shape 1518 may comprise or approximate an equilateral triangle, an isosceles triangle, etc. Further, the triangular shape 1518 may have straight or slightly rounded edges, and may have pointed or slightly rounded vertices depending on fabrication tolerances. However, other shapes are considered herein depending on fabrication tolerances, such as trapezoidal shapes, rectangular and triangular shapes, or some other shape. For example, FIG. 15E illustrates a cross-section of a fixed valve member 1310 having a generally rectangular and triangular shape 1528. A triangular shape 1518, trapezoidal shape, rectangular and triangular shape 1528, etc., may provide a technical benefit of improving the effectiveness of a passive valve 1102.

When having a triangular shape 1518 (or a rectangular and triangular shape 1528), a first edge 1520 and a second edge 1521 of the fixed valve member 1310 converge at a vertex 1524 that points generally toward the pressure chamber opening 712 of the channel fluid passage 520, as shown in FIG. 15D. A third edge 1522 of the fixed valve member 1310 faces toward the manifold opening 710 of the channel fluid passage 520. One technical benefit is the effectiveness of a passive valve 1102 may be improved. In an embodiment, the fixed valve member 1310 may be positioned closer to the pressure chamber opening 712 than the manifold opening 710. For example, the fixed valve member 1310 may be positioned as close to the pressure chamber opening 712 as possible based on fabrication tolerances. One technical benefit is the effectiveness of a passive valve 1102 may be improved.

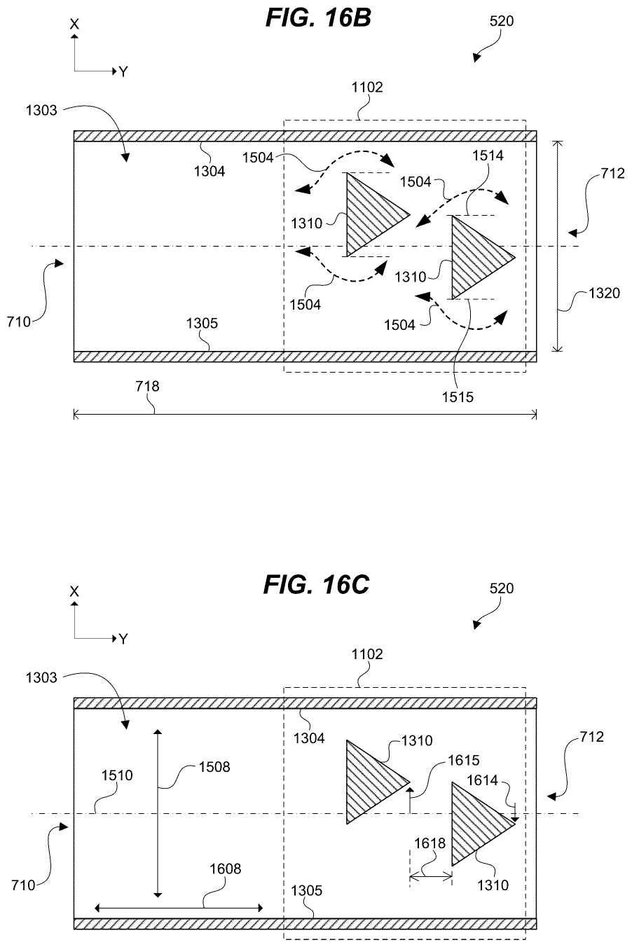

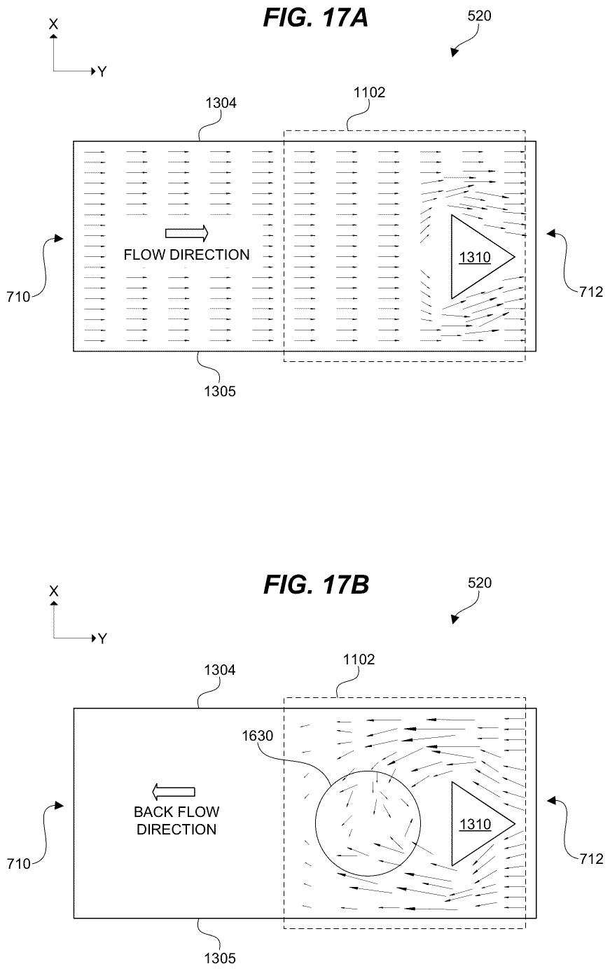

FIGS. 16A-16C are cross-sectional views of a channel fluid passage 520 in illustrative embodiments. The views in FIG. 16A-16C are of a cross-section taken along an x-y cut plane. FIGS. 16A-16C are not drawn to scale. In FIG. 16A, the passive valve 1102 formed in the channel fluid passage 520 comprises multiple fixed valve members 1310 (e.g., a first fixed valve member and a second fixed valve member) disposed between opposing side walls 1304-1305 across the width 1320 of the channel fluid passage 520. Each of the fixed valve members 1310 may have a similar structure, configuration, and/or positioning as described above. For example, each of the fixed valve members 1310 may have the same or similar a triangular shape 1518 as shown in FIG. 16A. There are physical separations 1502 between each of the fixed valve members 1310 and the side walls 1304-1305 of the channel fluid passage 520. In FIG. 16B, the physical separations 1502 are configured to form flow paths 1504 on opposing sides 1514-1515 of the fixed valve members 1310. One technical benefit is the effectiveness of a passive valve 1102 may be improved by comprising multiple fixed valve members 1310.

In an embodiment, one of the fixed valve members 1310 (e.g., the first fixed valve member) is disposed within the channel fluid passage 520 closer than the other of the fixed valve members 1310 (e.g., the second fixed valve member) to the pressure chamber opening 712. In an embodiment, the first fixed valve member 1310 and the second fixed valve member 1310 do not overlap in the widthwise direction 1508, as in FIG. 16C. However, the first fixed valve member 1310 and the second fixed valve member 1310 may at least partially overlap in the lengthwise direction 1608. One technical benefit is the effectiveness of a passive valve 1102 may be improved. In an embodiment, each of the fixed valve members 1310 is offset from the longitudinal centerline 1510 of the channel fluid passage 520. For example, the first fixed valve member 1310 may be offset from the longitudinal centerline 1510 in a first widthwise direction 1614, and the second fixed valve member 1310 may be offset from the longitudinal centerline 1510 in a second widthwise direction 1615 opposite the first widthwise direction 1614. Although the dimensions and/or positioning of the fixed valve members 1310 may vary, the first fixed valve member 1310 may be offset from the longitudinal centerline 1510 by a distance in a range of about 0.05 to 0.15 times the width 1320 of the channel fluid passage 520. The second fixed valve member 1310 may be offset from the longitudinal centerline 1510 by a distance in a range of about 0.4 to 0.6 times the width 1320 of the channel fluid passage 520. A spacing 1618 between the first fixed valve member 1310 and the second fixed valve member 1310 in the lengthwise direction 1608 may be in a range of about 0.3 to 0.5 times the width 1320 of the channel fluid passage 520. Any combination of these dimensions and/or positioning of the fixed valve members 1310 may provide a technical benefit of improving the effectiveness of a passive valve 1102.

FIGS. 17A-17B are flow diagrams illustrating a flow of print liquid through a channel fluid passage 520 in illustrative embodiments. FIGS. 17A-17B are not drawn to scale. FIG. 17A shows a flow of print liquid in channel fluid passage 520, which represents a flow in a normal flow direction through the channel fluid passage 520 from a manifold to a pressure chamber 412. The passive valve 1102 operates within the microfluidics regime to divide the flow. The passive valve 1102 allows print liquid to flow from left to right in FIG. 17A from a manifold opening 710 to a pressure chamber opening 712 (i.e., from a common manifold 518 towards a pressure chamber 418). The fixed valve member 1310 is an obstruction in the flow path of the print liquid configured to divide or disturb the flow of the print liquid along at least a portion of a length 718 of the channel fluid passage 520. The velocity of the print liquid slows as it approaches the fixed valve member 1310. As the fixed valve member 1310 divides the flow, a portion of the flow follows a flow path 1504 around one side 1514 of the fixed valve member 1310, and a portion of the flow follows a flow path 1504 around the other side 1515 of the fixed valve member 1310 (see FIG. 15B). As the print liquid flows around the fixed valve member 1310, the velocity or flow rate of the print liquid increases before or as the print liquid reaches the pressure chamber opening 712. One technical benefit is the turbulence created in the flow by the fixed valve member 1310 acts to mix the print liquid before entering the pressure chamber 412, which can restore homogeneity of the print liquid.

FIG. 17B shows a flow of print liquid in channel fluid passage 520 in the opposite direction, which represents a back flow in a back flow direction through at least a portion of the channel fluid passage 520 from a pressure chamber 412 to a manifold. A back flow is from right to left in FIG. 17B from a pressure chamber opening 712 to a manifold opening 710. Passive valve 1102 inhibits a back flow of print liquid from a pressure chamber 412 towards a common manifold 518. The fixed valve member 1310 is an obstruction in the back flow path of the print liquid configured to divide or disturb the back flow of the print liquid along at least a portion of a length 718 of the channel fluid passage 520. The velocity of any print liquid back-flowing in the channel fluid passage 520 slows as it approaches the fixed valve member 1310. As the fixed valve member 1310 divides the back flow, a portion of the back flow follows a flow path 1504 around one side 1514 of the fixed valve member 1310, and a portion of the flow follows a flow path 1504 around the other side 1515 of the fixed valve member 1310 (see FIG. 15B). The velocity or flow rate of any print liquid back-flowing around the fixed valve member 1310 increases, and then recombines behind (i.e., to the left) of the fixed valve member 1310, such as due to the shape and/or positioning of the fixed valve member 1310. This creates a local vortex 1630 that interferes with back flow of print liquid in the back flow direction. One technical benefit is the local vortex 1630 stalls a back flow of print liquid in the channel fluid passage 520, which reduces pressure drop in the pressure chamber 412. This restricts the applied energy (e.g., pressure waves) to within the pressure chamber 412, and focuses the applied energy to jetting from a nozzle 306. Thus, lower voltages may be used for jetting from a jetting channel 402, which makes a printhead 104 more efficient. Similar concepts apply when multiple fixed valve members 1310 are implemented in a passive valve 1102.

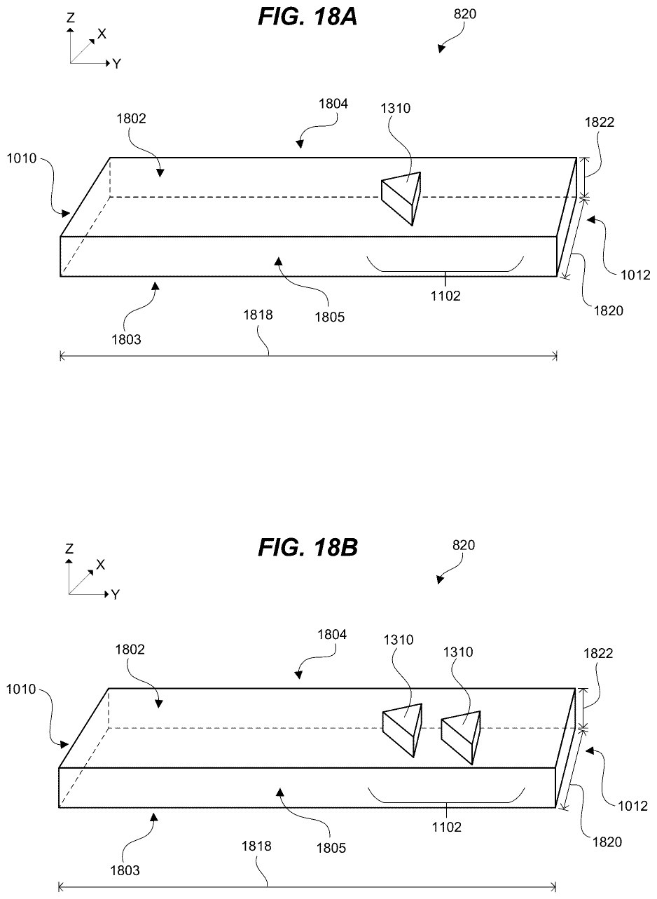

As described above (see FIG. 12), multiple passive valves 1102 may be disposed or formed within channel fluid passages 520/820 of jetting channels 402 in a flow-through type 804 of printhead 104. FIGS. 18A-18B are perspective views of a channel fluid passage 820 with a passive valve 1102 in an illustrative embodiment. In general, a channel fluid passage 820 is a rectangular and hollow channel, conduit, or duct configured to convey a print liquid. A channel fluid passage 820 has dimensions of a length 1818 in the y-direction, a width 1820 in the x-direction, and a height 1822 in the z-direction. The channel fluid passage 820 is defined by a top wall 1802 and an opposing bottom wall 1803. Top wall 1802 and bottom wall 1803 may comprise generally flat or planar surfaces disposed horizontally or generally parallel to a discharge surface 220 of the printhead 104. Top wall 1802 and bottom wall 1803 are separated by a distance in the z-direction that defines the height 1822 of the channel fluid passage 820. The channel fluid passage 820 is further defined by opposing side walls 1804-1805. Side walls 1804-1805 may comprise generally flat or planar surfaces disposed vertically or generally transverse to the top wall 1802 and bottom wall 1803, and transverse to the discharge surface 220 of the printhead 104. Side walls 1804-1805 are separated by a distance in the x-direction that defines the width 1820 of the channel fluid passage 820.

A passive valve 1102 may be disposed or formed within a channel fluid passage 820. The “body” or “casing” of a passive valve 1102 is defined by at least a portion of the top wall 1802, bottom wall 1803, and opposing side walls 1804-1805 of the channel fluid passage 820. The passive valve 1102 comprises one or more fixed valve members 1310 disposed between the opposing side walls 1804-1805 of the channel fluid passage 520. As in FIG. 18A, a passive valve 1102 may comprise a single fixed valve member 1310. As in FIG. 18B, a passive valve 1102 may comprise a plurality of fixed valve members 1310.

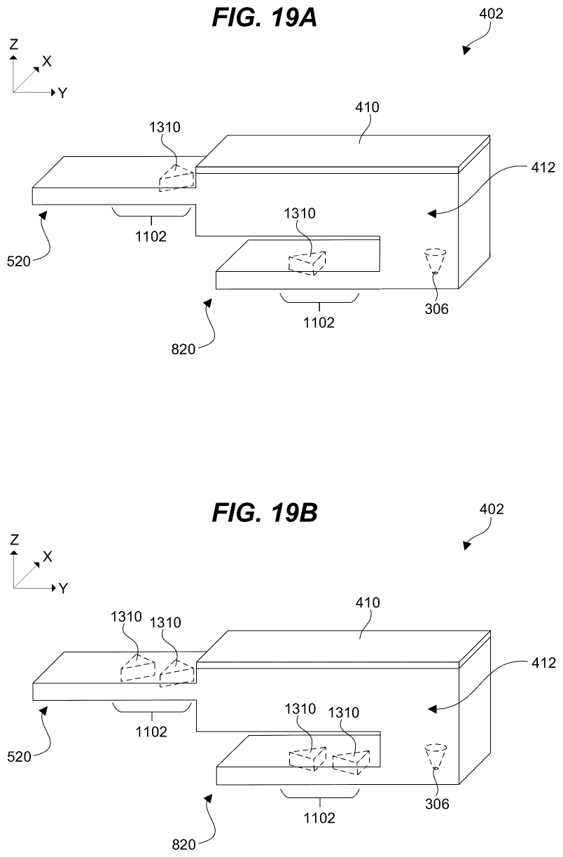

FIGS. 19A-19B are perspective views of a jetting channel 402 in illustrative embodiments. In FIG. 19A, a passive valve 1102 comprising a single fixed valve member 1310 is disposed or formed within the channel fluid passage 520 of the jetting channel 402, and a passive valve 1102 comprising a single fixed valve member 1310 is disposed or formed within the channel fluid passage 820 of the jetting channel 402. In FIG. 19B, a passive valve 1102 comprising a plurality of fixed valve members 1310 is disposed or formed within the channel fluid passage 520 of the jetting channel 402, and a passive valve 1102 comprising a plurality of fixed valve members 1310 is disposed or formed within the channel fluid passage 820 of the jetting channel 402.

The structure, dimensions, etc., of a passive valve 1102 disposed within the channel fluid passage 820 may be similar to a passive valve 1102 disposed within channel fluid passage 520. Thus, concepts described above for a passive valve 1102 may apply to either channel fluid passage 520/820. One technical benefit of these embodiments is that the walls of the channel fluid passages guide the fluid past the respective passive valves 1102.

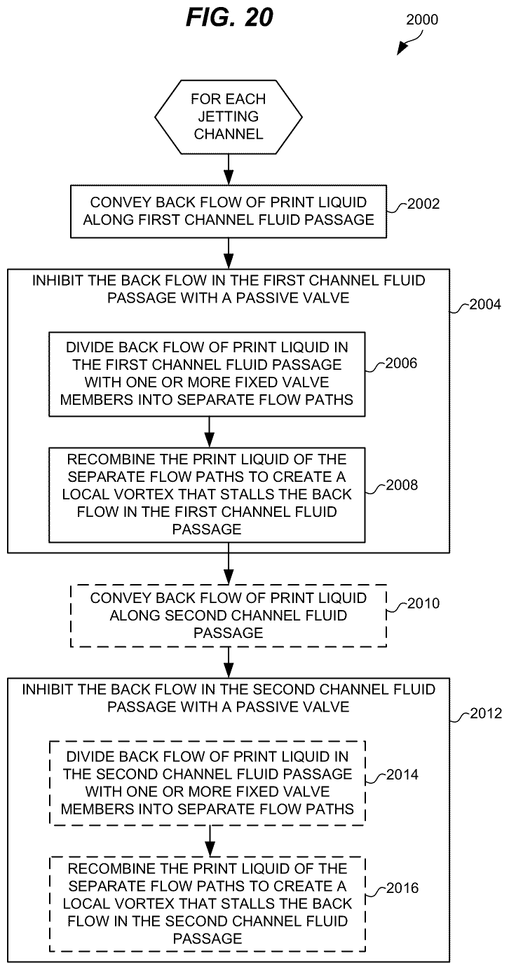

FIG. 20 is a flow chart illustrating a method 2000 of operating a printhead 104 in an illustrative embodiment. The steps of the flow charts described herein are not all inclusive and may include other steps not shown, and the steps may be performed in an alternative order. It is assumed for this embodiment that a printhead 104 includes (first) channel fluid passages 520 fluidly coupled between a manifold 518 and pressure chambers 412 of the jetting channels 402. For each jetting channel 402, a back flow of print liquid is conveyed along at least a portion of the length 718 of a channel fluid passage 520 from the pressure chamber 412 toward the manifold 518 (step 2002). A passive valve 1102 in the channel fluid passage 520 inhibits or stalls the back flow in the channel fluid passage 520 (step 2004). To implement the passive valve 1102, one or more fixed valve members 1310 are disposed in the channel fluid passage 520 to divide the back flow of print liquid into separate flow paths 1504 (step 2006). The print liquid of the separate flow paths 1504 recombine to create a local vortex 1630 in the channel fluid passage 520 that stalls the back flow in the channel fluid passage 520 (step 2008). One technical benefit is the passive valve 1102 reduces pressure drop in the pressure chamber 412. Thus, lower voltages may be used for jetting from a jetting channel 402, which makes a printhead 104 more efficient.

In an embodiment, a printhead 104 may include (second) channel fluid passages 820 fluidly coupled between the same or another manifold 818 and pressure chambers 412 of the jetting channels 402. For each jetting channel 402, a back flow of print liquid is conveyed along at least a portion of the length of a channel fluid passage 820 from the manifold 818 toward the pressure chamber 412 (optional step 2010). A passive valve 1102 in the channel fluid passage 820 inhibits or stalls the back flow in the channel fluid passage 820 (step 2012). To implement the passive valve 1102, one or more fixed valve members 1310 disposed in the channel fluid passage 820 divide the back flow of print liquid into separate flow paths 1504 (optional step 2014). The print liquid of the separate flow paths 1504 recombine to create a local vortex 1630 in the channel fluid passage 820 that stalls the back flow in the channel fluid passage 820 (optional step 2016). One technical benefit is the passive valve 1102 reduces pressure drop in the pressure chamber 412. Thus, lower voltages may be used for jetting from a jetting channel 402, which makes a printhead 104 more efficient.

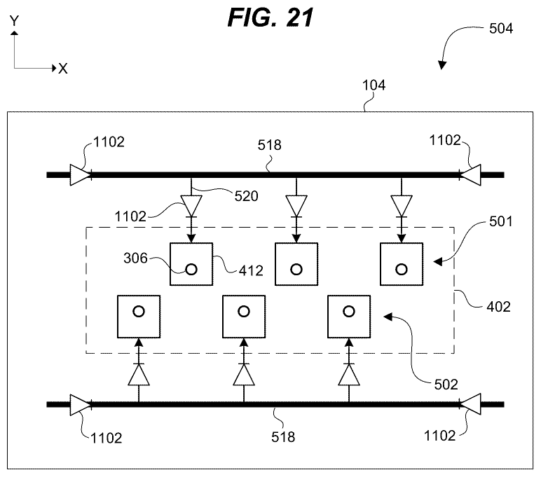

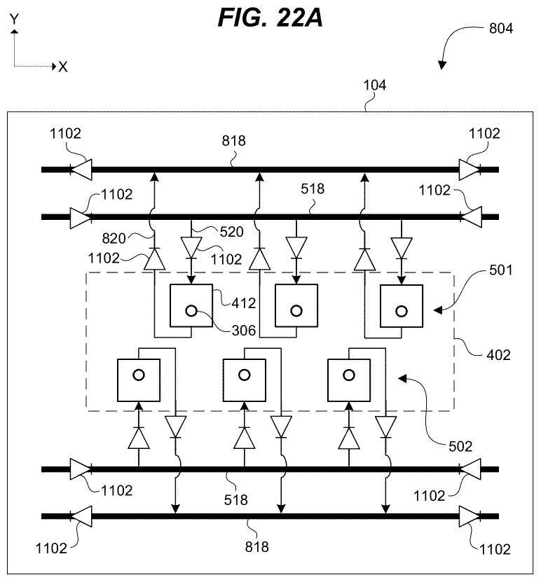

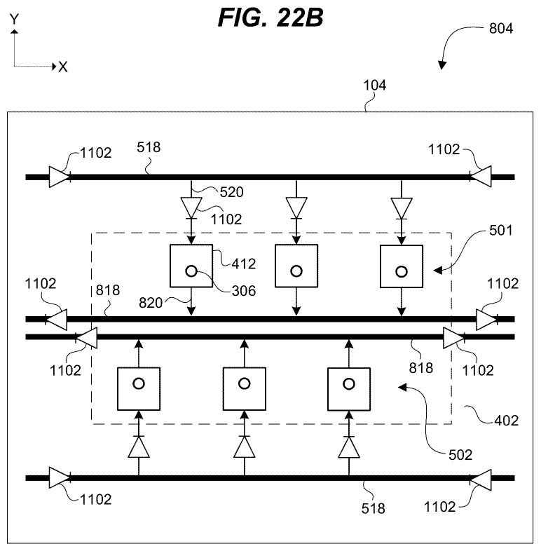

In the embodiments above, passive valves 1102 are implemented in the channel fluid passages 520/820 of the individual jetting channels 402 of the printhead 104. In an embodiment, passive valves 1102 may be implemented in other fluid passageways of the printhead 104. FIG. 21 is a schematic diagram of a non-flow-through type 504 of printhead 104 in an illustrative embodiment. FIG. 21 is a magnified view of a plurality of jetting channels 402 schematically illustrated as pressure chambers 412 and nozzles 306 in two nozzle rows 501-502, such as shown in FIG. 11. In this embodiment, one or more passive valves 1102 may be disposed in a manifold 518 fluidly coupled to jetting channels 402. FIG. 22A is a schematic diagram of a flow-through type 804 of printhead 104 in an illustrative embodiment. FIG. 22A is a magnified view of a plurality of jetting channels 402 schematically illustrated as pressure chambers 412 and nozzles 306 in two nozzle rows 501-502, such as shown in FIG. 12A. In this embodiment, one or more passive valves 1102 may be disposed in manifold 518 and/or manifold 818 fluidly coupled to jetting channels 402. FIG. 22B is a schematic diagram of a flow-through type 804 of printhead 104 in an illustrative embodiment. FIG. 22B is a magnified view of a plurality of jetting channels 402 schematically illustrated as pressure chambers 412 and nozzles 306 in two nozzle rows 501-502, such as shown in FIG. 12B. In this embodiment, one or more passive valves 1102 may be disposed in manifold 518 and/or manifold 818 fluidly coupled to jetting channels 402. One technical benefit for the above embodiments (FIG. 21, FIG. 22A, or FIG. 22B) is that the passive valves 1102 of jetting channels 402 restrict or confine applied energy from an actuator to the pressure chambers 412.

Regarding FIG. 22A, for example, passive valves 1102 may be disposed in both channel fluid passages 520 and 820, and in both manifolds 518 and 818. However, passive valves 1102 may be configured in other combinations. In an embodiment, passive valves 1102 may be disposed in channel fluid passage 520 and manifold 818, and not in channel fluid passage 820 and manifold 518. In an embodiment, passive valves 1102 may be disposed in channel fluid passage 820 and manifold 518, and not in channel fluid passage 520 and manifold 818. In an embodiment, when a passive valve 1102 is not disposed in a channel fluid passage 520/820, a passive valve 1102 may be disposed in a manifold 518/818 that is fluidly coupled to that channel fluid passage 520/820. For example, when a passive valve 1102 is not disposed in a channel fluid passage 820, a passive valve 1102 may be disposed in a manifold 818 that is fluidly coupled to that channel fluid passage 820. In another example, when a passive valve 1102 is not disposed in a channel fluid passage 520, a passive valve 1102 may be disposed in a manifold 518 that is fluidly coupled to that channel fluid passage 520. Similar concepts apply to a structure illustrated in FIG. 22B. One technical benefit is manufacturing processes may be simplified when passive valves 1102 are disposed in select channel fluid passages (e.g., either channel fluid passages 520 or channel fluid passages 820), yet directional flow control is maintained with the passive valves 1102 in the manifolds 518/818.

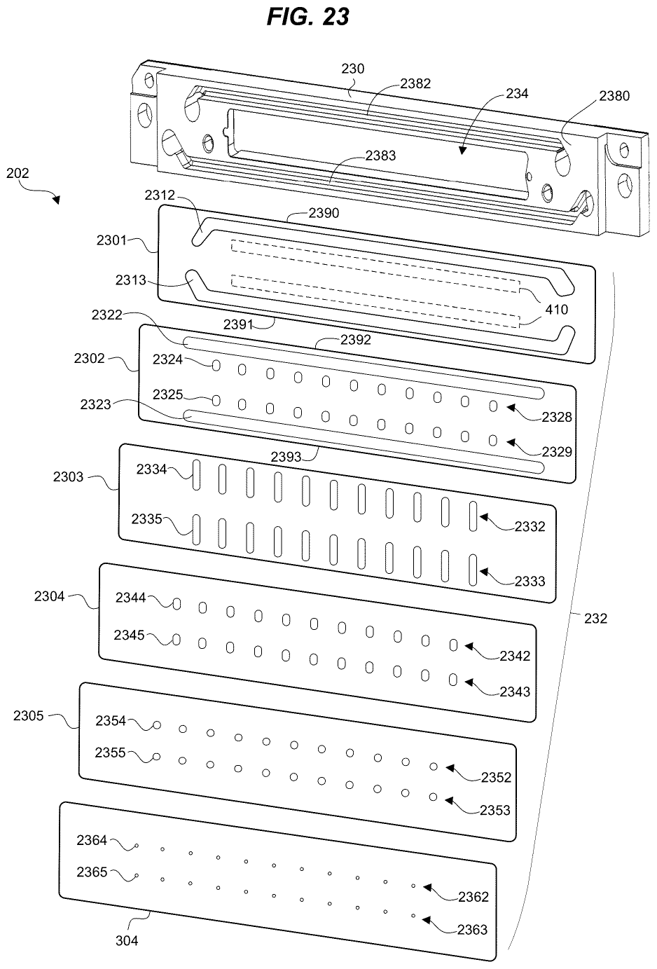

FIG. 23 illustrates an exploded, perspective view of a head member 202 of a printhead 104 in an illustrative embodiment. In an embodiment, head member 202 is an assembly that includes housing 230 and plate stack 232. Plate stack 232 is affixed or bonded to an interface surface 2380 of housing 230, and forms one or more rows of jetting channels 402. Housing 230 is an elongated member made from a rigid material, such as stainless steel or another metal substrate. Housing 230 has a length, a width, and a height, and the dimensions of housing 230 are such that the length is greater than the width. The direction of a row of jetting channels 402 corresponds with the length of housing 230. Housing 230 includes access hole 234 at or near its center that extends from I/O surface (not visible) through to an opposing interface surface 2380. Access hole 234 provides passageway for an actuator assembly (not shown), such as a plurality of piezoelectric actuators, to pass through and contact diaphragms 410 of the jetting channels 402. Interface surface 2380 is the surface of housing 230 that faces plate stack 232, and interfaces with a plate of plate stack 232. Housing 230 also includes manifold ducts 2382-2383 that extend longitudinally along a length of interface surface 2380. A manifold duct 2382-2383 comprises an elongated cut or groove along interface surface 2380 that is configured to convey a print liquid, and forms at least a portion of a manifold for printhead 104.

Plate stack 232 includes a series of plates 2301-2305 and 304 that are fixed or bonded to one another to form a laminated plate structure. Plate stack 232 illustrated in FIG. 23 is intended to be an example of a basic structure of a non-flow-through type 504 of printhead 104. There may be additional plates of plate stack 232 that are not shown in FIG. 23, and the configuration of the various plates may vary as desired. Also, FIG. 23 is not drawn to scale. One technical benefit is the plate stack 232 defines jetting channels 402 that effectively jet print liquid.

In an embodiment, plate stack 232 includes the following plates: a diaphragm plate 2301, a support plate 2302, a restrictor plate 2303, chamber plates 2304-2305, and a nozzle plate 304. Diaphragm plate 2301 is a thin layer or sheet of material (e.g., a metal substrate) that is generally rectangular in shape and is substantially flat or planar. Diaphragm plate 2301 comprises a sheet of a semi-flexible material that forms the diaphragms 410 of the jetting channels 402. Diaphragm plate 2301 further includes elongated manifold apertures 2312-2313. An elongated manifold aperture is an aperture or hole through a plate that forms at least part of a manifold for jetting channels 402. Elongated manifold aperture 2312 extends longitudinally along diaphragm plate 2301 between a longitudinal side 2390 of diaphragm plate 2301 and diaphragms 410 for a row of jetting channels 402, and is fluidly coupled with a manifold duct 2382 of housing 230. Elongated manifold aperture 2313 extends longitudinally along diaphragm plate 2301 between the other longitudinal side 2391 of diaphragm plate 2301 and diaphragms 410 for another row of jetting channels 402, and is fluidly coupled with a manifold duct 2383 of housing 230.

Support plate 2302 (also referred to as a spacer plate) is a thin layer or sheet of material (e.g., a metal substrate) that is generally rectangular in shape and is substantially flat or planar. Support plate 2302 includes elongated manifold apertures 2322-2323 and chamber openings 2324-2325. In general, a chamber opening is an aperture or hole through a plate that forms at least part of a pressure chamber 412 for a jetting channel 402. Thus, chamber openings 2324 comprise apertures or holes through support plate 2302 generally aligned longitudinally in a linear row 2328, and configured to form at least part of the pressure chambers 412 in a first row 501 of jetting channels 402. Elongated manifold aperture 2322 is an elongated hole that extends longitudinally along support plate 2302 between a longitudinal side 2392 of support plate 2302 and chamber openings 2324 in linear row 2328, and generally in parallel with the linear row 2328 of chamber openings 2324. Chamber openings 2325 comprise apertures or holes through support plate 2302 generally aligned longitudinally in a linear row 2329, and configured to form at least part of the pressure chambers 412 for a second (adjacent) row 502 of jetting channels 402. Elongated manifold aperture 2323 is an elongated hole that extends longitudinally along support plate 2302 between the other longitudinal side 2393 of support plate 2302 and chamber openings 2325 in linear row 2329, and generally in parallel with the linear row 2329 of chamber openings 2325.

Restrictor plate 2303 is a thin layer or sheet of material (e.g., a metal substrate) that is generally rectangular in shape and is substantially flat or planar. Restrictor plate 2303 includes restrictor openings 2334-2335. In general, a restrictor opening is an elongated aperture or hole through a plate that defines at least in part a channel fluid passage 520 (also referred to as a restrictor) between a manifold and a pressure chamber 412 of an individual jetting channel 402. Restrictor openings 2334 are elongated apertures or holes through restrictor plate 2303 each oriented transversely, and generally aligned longitudinally in a linear row 2332. Restrictor openings 2334 are configured to fluidly couple pressure chambers 412 of a first row 501 of jetting channels 402 with a manifold (i.e., formed by manifold duct 2382, elongated manifold aperture 2322, elongated manifold aperture 2312, etc.). Restrictor openings 2335 are elongated apertures or holes through restrictor plate 2303 each oriented transversely, and generally aligned longitudinally in a linear row 2333. Restrictor openings 2335 are configured to fluidly couple pressure chambers 412 of jetting channels 402 in a second row 502 with a manifold (i.e., formed by manifold duct 2383, elongated manifold aperture 2323, elongated manifold aperture 2313, etc.).

Chamber plate 2304 is a thin layer or sheet of material (e.g., a metal substrate) that is generally rectangular in shape and substantially flat or planar. Chamber plate 2304 includes chamber openings 2344-2345. Chamber openings 2344 are apertures or holes through chamber plate 2304 generally aligned longitudinally in a linear row 2342, and form at least part of the pressure chambers 412 of jetting channels 402 in a first row 501. Chamber openings 2345 are apertures or holes through chamber plate 2304 generally aligned longitudinally in a linear row 2343, and form at least part of the pressure chambers 412 of jetting channels 402 in a second row 502.

Chamber plate 2305 is a thin layer or sheet of material (e.g., a metal substrate) that is generally rectangular in shape and substantially flat or planar. Chamber plate 2305 includes chamber openings 2354-2355. Chamber openings 2354 are apertures or holes through chamber plate 2305 generally aligned longitudinally in a linear row 2352, and form at least part of the pressure chambers 412 of jetting channels 402 in a first row 501. Chamber openings 2355 are apertures or holes through chamber plate 2305 generally aligned longitudinally in a linear row 2353, and form at least part of the pressure chambers 412 of jetting channels 402 in a second row 502.

Nozzle plate 304 is a thin layer or sheet of material (e.g., a metal substrate) that is generally rectangular in shape and substantially flat or planar. Nozzle plate 304 includes nozzle holes 2364-2365 that form nozzles 306 of the jetting channels 402. For example, nozzle holes 2364 may be generally aligned longitudinally in a linear row 2362 to form the nozzles 306 of jetting channels 402 in a first row 501, and nozzle holes 2365 may be generally aligned longitudinally in a linear row 2363 to form the nozzles 306 of jetting channels 402 in a second row 502.

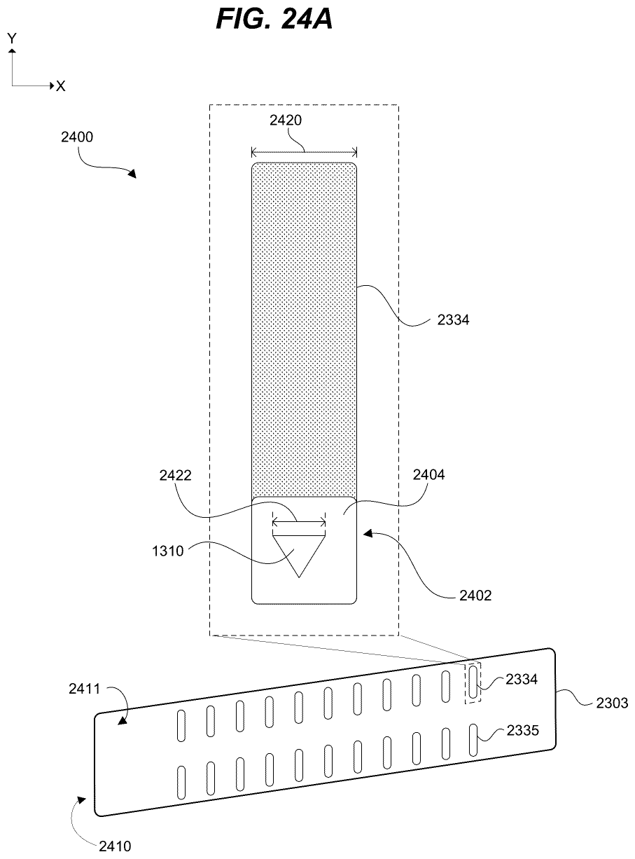

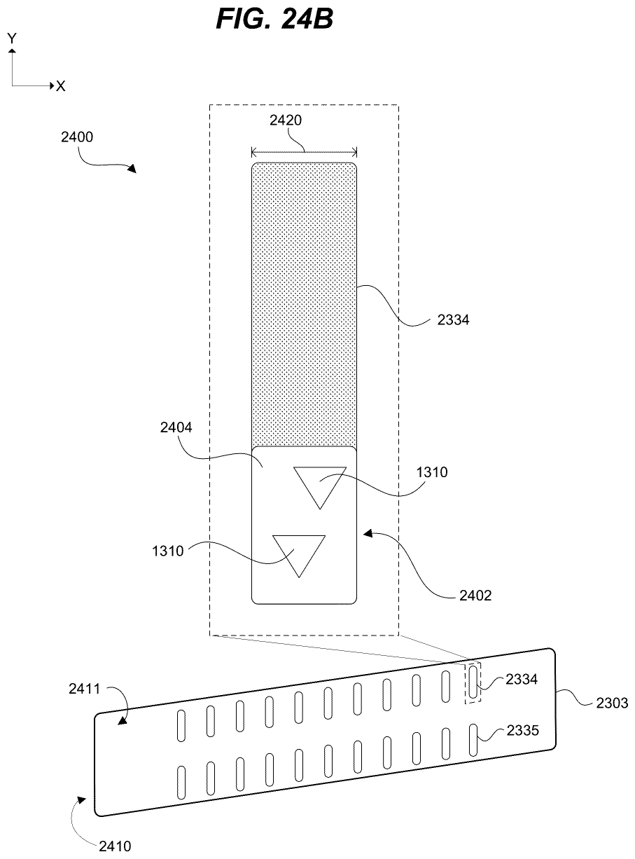

FIGS. 24A-24B are perspective views of restrictor plate 2303 in illustrative embodiments. As described above, restrictor plate 2303 is a substantially flat substrate, and thus has opposing surfaces 2410-2411. Surface 2410 faces toward the discharge surface 220 of the printhead 104, while surface 2411 faces toward housing 230. Magnification window 2400 illustrates a magnified view of restrictor plate 2303 corresponding with an individual jetting channel 402, and it is understood that the structure of restrictor plate 2303 is similar for each jetting channel 402. Restrictor plate 2303 includes a restrictor opening 2334 that at least in part defines a restrictor (or a channel fluid passage 520) for a jetting channel 402. For the sake of clarity, an opening through the restrictor plate 2303, such as a restrictor opening 2334, is shown with dotted shading. Restrictor plate 2303 further comprises valve structures 2402 that extend across the restrictor openings 2334 (i.e., across a width 2420 of the restrictor openings 2334 in the x-direction). The valve structures 2402 each comprise a support element 2404, and one or more fixed valve members 1310 disposed on the support element 2404. In FIG. 24A, a valve structure 2402 may comprise a single fixed valve member 1310 disposed on the support element 2404. In FIG. 24B, a valve structure 2402 may comprise a plurality of fixed valve members 1310 disposed on the support element 2404. In an embodiment, a surface 2410/2411 of restrictor plate 2303 may be etched or patterned with the valve structures 2402. The etching controls or defines the size, shape, positioning, etc., of the fixed valve member(s) 1310. In an embodiment, the valve structures 2402 may be formed or patterned on a surface 2410/2411 of restrictor plate 2303 with an additive manufacturing process or the like. One technical benefit is passive valves 1102 may be defined in channel fluid passages.

In general, the fixed valve member(s) 1310 formed at a restrictor opening 2334 is smaller than the restrictor opening 2334. As described above, there are physical separations between a fixed valve member 1310 and side walls of a channel fluid passage 520. Thus, the fixed valve member(s) 1310 has a width 2422 less than the width 2420 of the restrictor opening 2334. One technical benefit is the effectiveness of a passive valve 1102 may be improved.

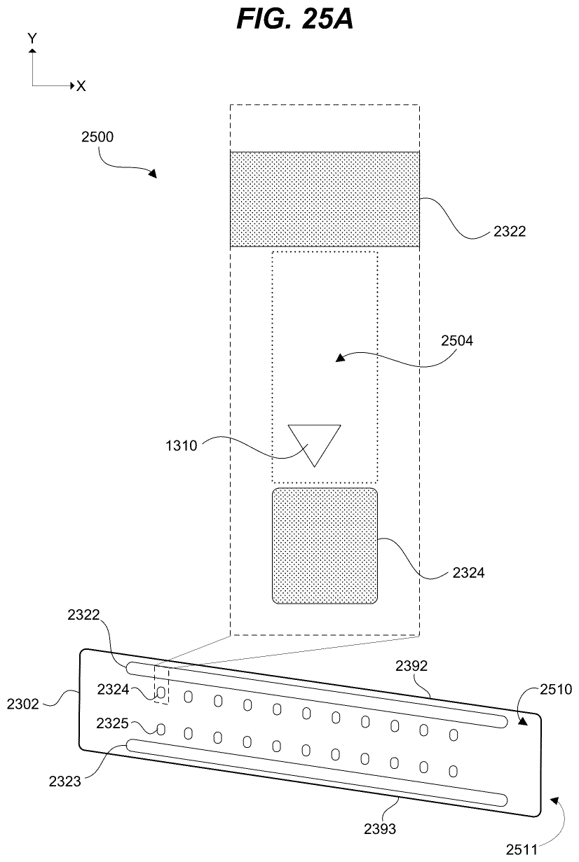

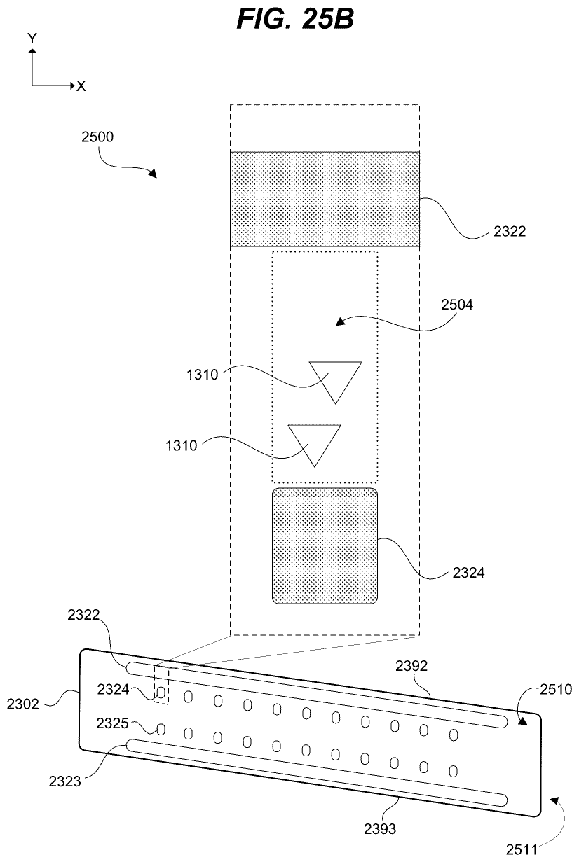

FIGS. 25A-25B are perspective views of support plate 2302 in illustrative embodiments. As described above, support plate 2302 is a substantially flat substrate, and thus has opposing surfaces 2510-2511. Surface 2510 faces toward the discharge surface 220 of the printhead 104, while surface 2511 faces toward housing 230. Magnification window 2500 illustrates a magnified view of support plate 2302 corresponding with an individual jetting channel 402, and it is understood that the structure of support plate 2302 is similar for each jetting channel 402. Support plate 2302 includes an elongated manifold aperture 2322 and a chamber opening 2324. For the sake of clarity, an opening through the support plate 2302, such as elongated manifold aperture 2322 and chamber opening 2324, is shown with dotted shading. Elongated manifold aperture 2322 forms at least part of a manifold 518, and chamber opening 2324 forms at least part of a pressure chamber 412. A portion or region of surface 2510 (e.g., between chamber opening 2324 and elongated manifold aperture 2322, or between chamber opening 2324 and longitudinal side 2392) forms a wall of a channel fluid passage 520 or restrictor for a jetting channel 402, such as top wall 1302 as shown in FIGS. 13A-13B, and is referred to herein as a restrictor wall surface 2504. One or more fixed valve members 1310 may be disposed or formed on the restrictor wall surface 2504. In FIG. 25A, a single fixed valve member 1310 is disposed on the restrictor wall surface 2504. In FIG. 25B, a plurality of fixed valve members 1310 are disposed on the restrictor wall surface 2504. The fixed valve member(s) 1310 projects from restrictor wall surface 2504 of support plate 2302 in a region of support plate 2302 that coincides with a restrictor opening 2334 of restrictor plate 2303. In an embodiment, the restrictor wall surface 2504 of support plate 2302 may be etched or patterned with the fixed valve member(s) 1310. In an embodiment, the fixed valve member(s) 1310 may be formed or patterned on the restrictor wall surface 2504 of support plate 2302 with an additive manufacturing process or the like. One technical benefit is passive valves 1102 may be defined in channel fluid passages.

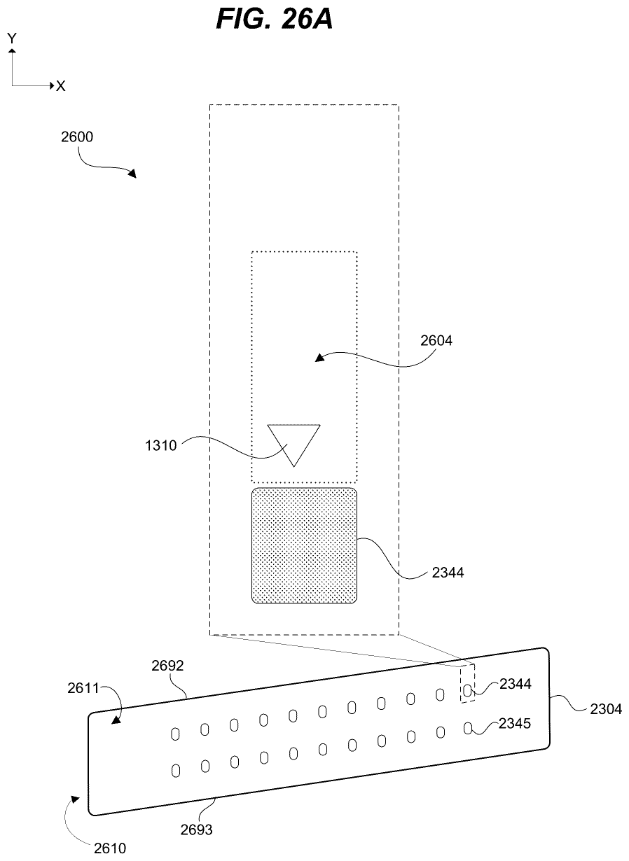

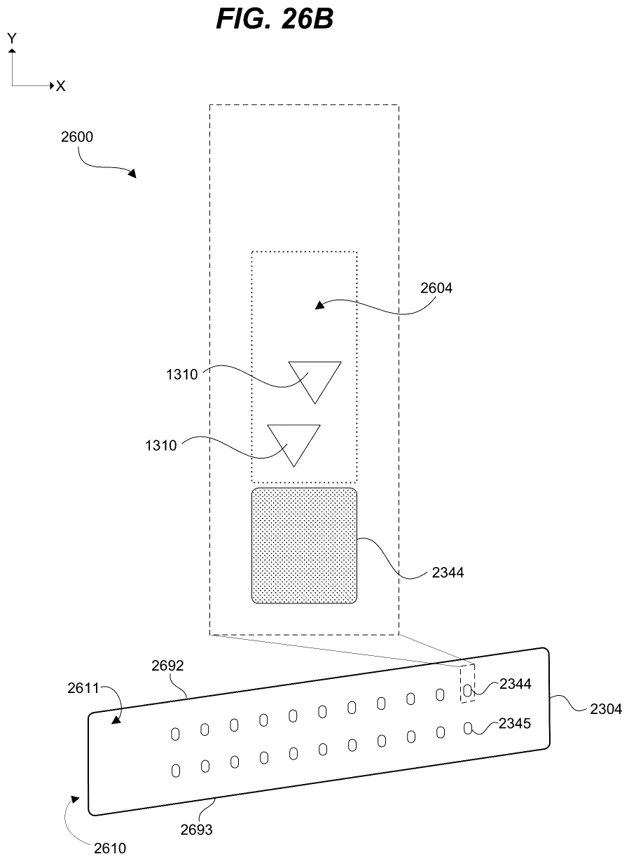

FIGS. 26A-26B are perspective views of chamber plate 2304 in illustrative embodiments. As described above, chamber plate 2304 is a substantially flat substrate, and thus has opposing surfaces 2610-2611 (and longitudinal sides 2692-2693). Surface 2610 faces toward the discharge surface 220 of the printhead 104, while surface 2611 faces toward housing 230. Magnification window 2600 illustrates a magnified view of chamber plate 2304 corresponding with an individual jetting channel 402, and it is understood that the structure of chamber plate 2304 is similar for each jetting channel 402. Chamber plate 2304 includes a chamber opening 2344 that forms at least part of a pressure chamber 412. For the sake of clarity, an opening through the chamber plate 2304, such as chamber opening 2344, is shown with dotted shading. A portion or region of surface 2611 (e.g., between chamber opening 2344 and longitudinal side 2692) forms a wall of a channel fluid passage 520 or restrictor for a jetting channel 402, such as bottom wall 1303 as shown in FIGS. 13A-13B, and is referred to herein as a restrictor wall surface 2604. One or more fixed valve members 1310 may be disposed or formed on the restrictor wall surface 2604. In FIG. 26A, a single fixed valve member 1310 is disposed on the restrictor wall surface 2604. In FIG. 26B, a plurality of fixed valve members 1310 are disposed on the restrictor wall surface 2604. The fixed valve member(s) 1310 projects from restrictor wall surface 2604 of chamber plate 2304 in a region of chamber plate 2304 that coincides with a restrictor opening 2334 of restrictor plate 2303. In an embodiment, the restrictor wall surface 2604 of chamber plate 2304 may be etched or patterned with the fixed valve member(s) 1310. In an embodiment, the fixed valve member(s) 1310 may be formed or patterned on the restrictor wall surface 2604 of chamber plate 2304 with an additive manufacturing process or the like. One technical benefit is passive valves 1102 may be defined in channel fluid passages.

It is noted that the structure of the plates described above may be used for a flow-through type 804 of printhead 104 as described in FIG. 8C, for example.

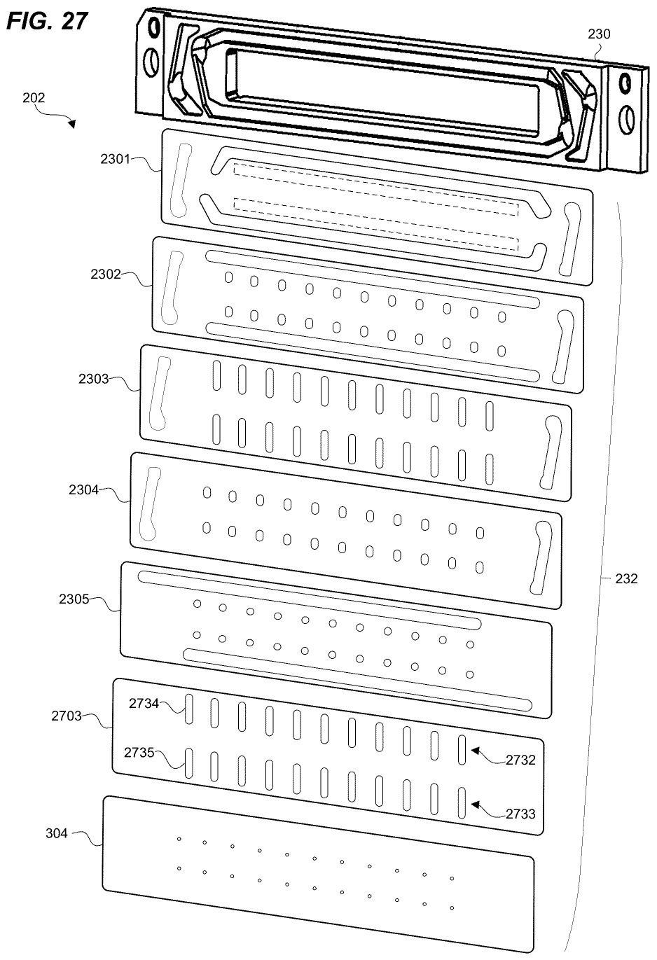

FIG. 27 illustrates an exploded, perspective view of a head member 202 of a printhead 104 in an illustrative embodiment. Plate stack 232 includes a series of plates 2301-2305, 2703, and 304 that are fixed or bonded to one another to form a laminated plate structure. Plate stack 232 illustrated in FIG. 27 is intended to be an example of a basic structure of a flow-through type 804 of printhead 104. There may be additional plates of plate stack 232 that are not shown in FIG. 27, and the configuration of the various plates may vary as desired. Also, FIG. 27 is not drawn to scale.

In an embodiment, plate stack 232 includes the following plates: a diaphragm plate 2301, a support plate 2302, a (first) restrictor plate 2303, chamber plates 2304-2305, and a nozzle plate 304. These plates may be similar to the plates described above for FIG. 23. In addition, plate stack 232 includes another (second) restrictor plate 2703. Restrictor plate 2703 is a thin layer or sheet of material (e.g., a metal substrate) that is generally rectangular in shape and is substantially flat or planar. Restrictor plate 2703 includes restrictor openings 2734-2735. In general, a restrictor opening is an elongated aperture or hole through a plate that defines a channel fluid passage 820 (also referred to as a restrictor) between a manifold and a pressure chamber 412 of an individual jetting channel 402. Restrictor openings 2734 are elongated apertures or holes through restrictor plate 2703 each oriented transversely, and generally aligned longitudinally in a linear row 2732. Restrictor openings 2734 are configured to fluidly couple pressure chambers 412 of a first row 501 of jetting channels 402 with a manifold. Restrictor openings 2735 are elongated apertures or holes through restrictor plate 2703 each oriented transversely, and generally aligned longitudinally in a linear row 2733. Restrictor openings 2735 are configured to fluidly couple pressure chambers 412 of jetting channels 402 in a second row 502 with a manifold.

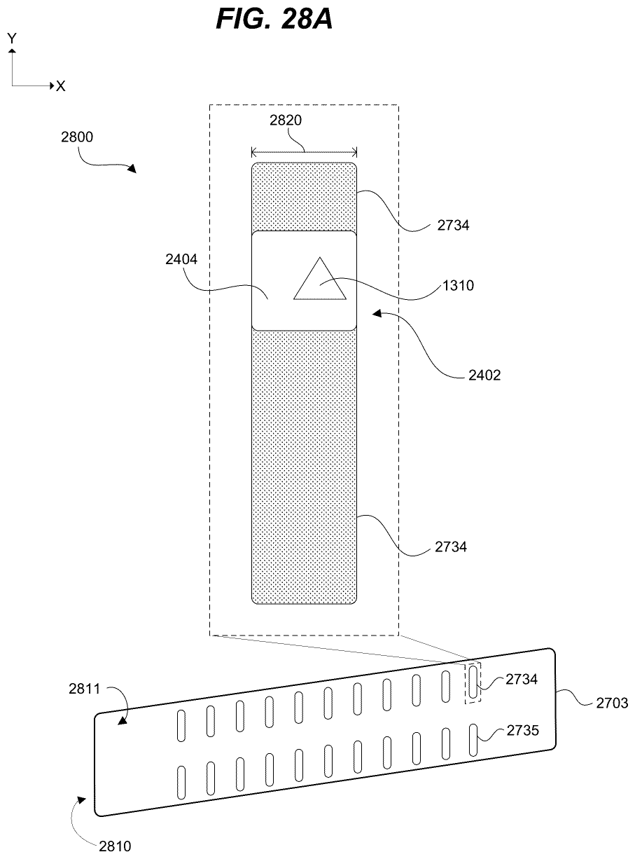

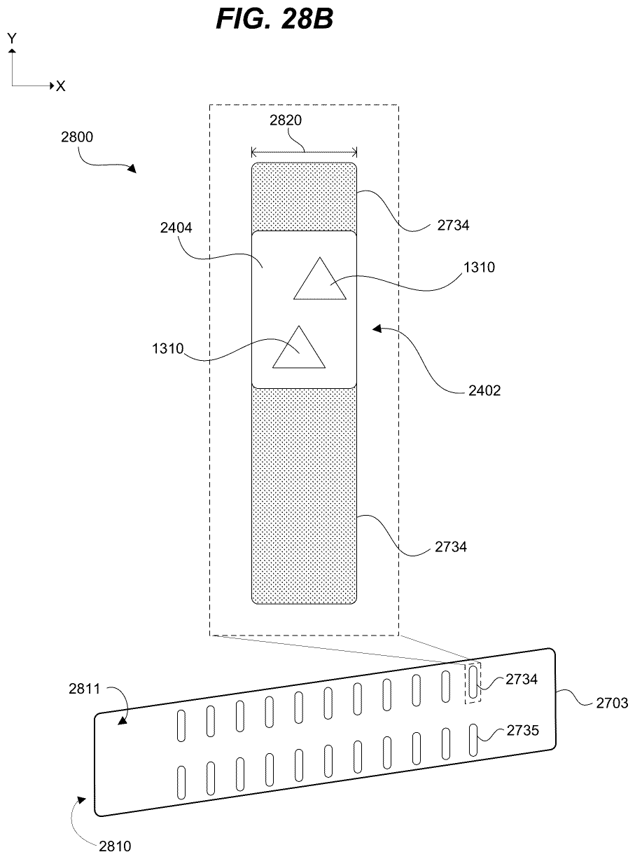

FIGS. 28A-28B are perspective views of restrictor plate 2703 in illustrative embodiments. As described above, restrictor plate 2703 is a substantially flat substrate, and thus has opposing surfaces 2810-2811. Surface 2810 faces toward the discharge surface 220 of the printhead 104, while surface 2811 faces toward housing 230. Magnification window 2800 illustrates a magnified view of restrictor plate 2703 corresponding with an individual jetting channel 402, and it is understood that the structure of restrictor plate 2703 is similar for each jetting channel 402. Restrictor plate 2703 includes a restrictor opening 2734 that at least in part defines a restrictor (or a channel fluid passage 820) for a jetting channel 402. For the sake of clarity, an opening through the restrictor plate 2703, such as a restrictor opening 2734, is shown with dotted shading. Restrictor plate 2703 further comprises valve structures 2402 that extend across the restrictor openings 2734 (i.e., across a width 2820 of the restrictor openings 2734 in the x-direction). The valve structures 2402 each comprise a support element 2404, and one or more fixed valve members 1310 disposed on the support element 2404. In FIG. 28A, a valve structure 2402 may comprise a single fixed valve member 1310 disposed on the support element 2404. In FIG. 28B, a valve structure 2402 may comprise a plurality of fixed valve members 1310 disposed on the support element 2404. In an embodiment, a surface 2810/2811 of restrictor plate 2703 may be etched or patterned with the valve structures 2402. The etching controls or defines the size, shape, positioning, etc., of the fixed valve member(s) 1310. In an embodiment, the valve structures 2402 may be formed or patterned on a surface 2810/2811 of restrictor plate 2703 with an additive manufacturing process or the like. One technical benefit is passive valves 1102 may be defined in channel fluid passages.

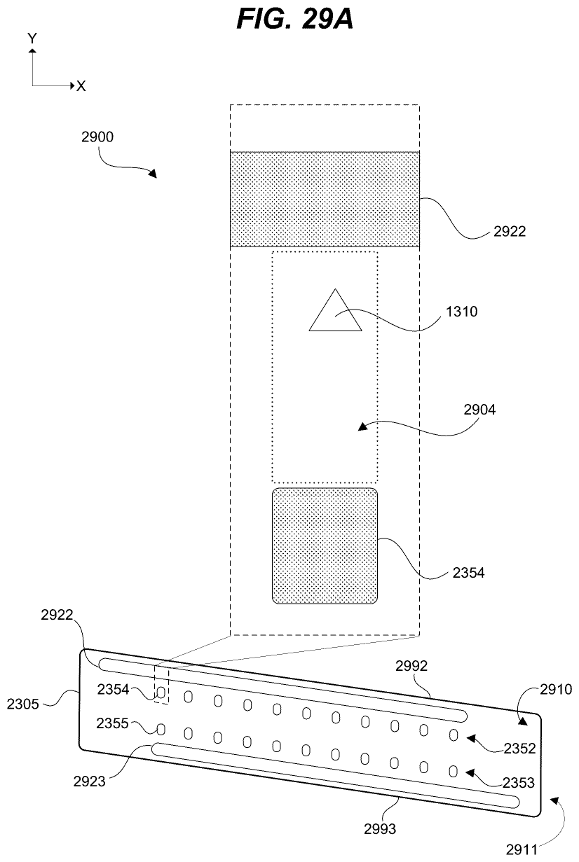

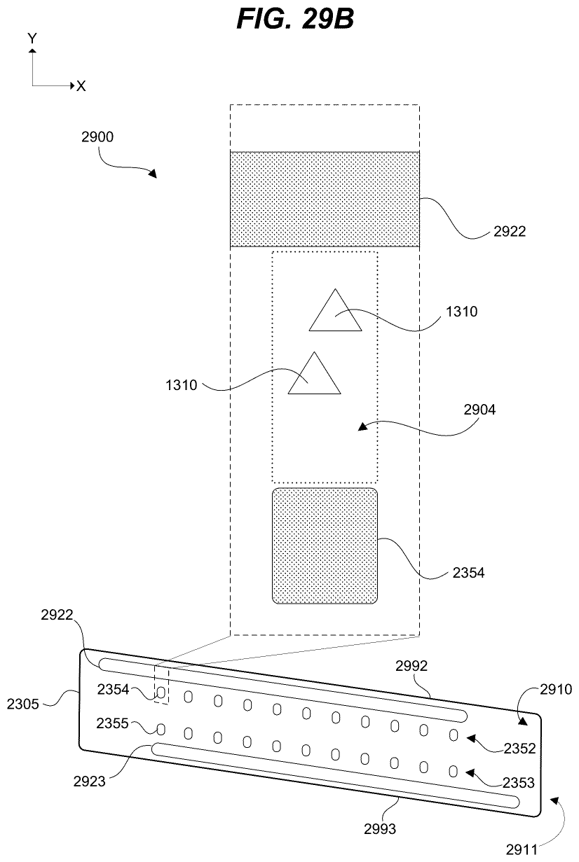

FIGS. 29A-29B are perspective views of chamber plate 2305 in illustrative embodiments. As described above, chamber plate 2305 is a substantially flat substrate, and thus has opposing surfaces 2910-2911 (and longitudinal sides 2992-2993). Surface 2910 faces toward the discharge surface 220 of the printhead 104, while surface 2911 faces toward housing 230. In this embodiment, chamber plate 2305 includes elongated manifold apertures 2922-2923 and chamber openings 2354-2355. Chamber openings 2354 comprise apertures or holes through chamber plate 2305 generally aligned longitudinally in a linear row 2352, and configured to form at least part of the pressure chambers 412 in a first row 501 of jetting channels 402. Elongated manifold aperture 2922 is an elongated opening that extends longitudinally along chamber plate 2305 between a longitudinal side 2992 of chamber plate 2305 and chamber openings 2354 in linear row 2352, and generally in parallel with the linear row 2352 of chamber openings 2354. Chamber openings 2355 comprise apertures or holes through chamber plate 2305 generally aligned longitudinally in a linear row 2353, and configured to form at least part of the pressure chambers 412 for a second (adjacent) row 502 of jetting channels 402. Elongated manifold aperture 2923 is an elongated opening that extends longitudinally along chamber plate 2305 between the other longitudinal side 2993 of chamber plate 2305 and chamber openings 2355 in linear row 2353, and generally in parallel with the linear row 2353 of chamber openings 2355.

Magnification window 2900 illustrates a magnified view of chamber plate 2305 corresponding with an individual jetting channel 402, and it is understood that the structure of chamber plate 2305 is similar for each jetting channel 402. Chamber plate 2305 includes a chamber opening 2354 that forms at least part of a pressure chamber 412. For the sake of clarity, an opening through the chamber plate 2305, such as chamber opening 2354 and elongated manifold aperture 2922, is shown with dotted shading. A portion or region of surface 2910 (e.g., between chamber opening 2354 and elongated manifold aperture 2922 or between chamber opening 2354 and longitudinal side 2992) forms a wall of a channel fluid passage 820 or restrictor for a jetting channel 402, such as top wall 1802 as shown in FIGS. 18A-18B, and is referred to herein as a restrictor wall surface 2904. One or more fixed valve members 1310 may be disposed or formed on the restrictor wall surface 2904. In FIG. 29A, a single fixed valve member 1310 is disposed on the restrictor wall surface 2904. In FIG. 29B, a plurality of fixed valve members 1310 are disposed on the restrictor wall surface 2904. The fixed valve member(s) 1310 projects from restrictor wall surface 2904 of chamber plate 2305 in a region of chamber plate 2305 that coincides with a restrictor opening 2734 of restrictor plate 2703. In an embodiment, the restrictor wall surface 2904 of chamber plate 2305 may be etched or patterned with the fixed valve member(s) 1310. In an embodiment, the fixed valve member(s) 1310 may be formed or patterned on the restrictor wall surface 2904 of chamber plate 2305 with an additive manufacturing process or the like. One technical benefit is passive valves 1102 may be defined in channel fluid passages.

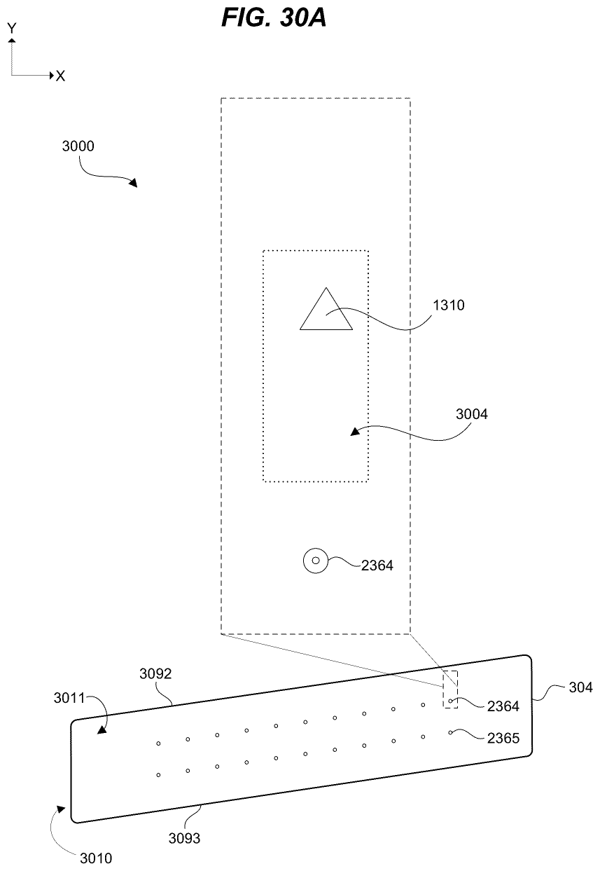

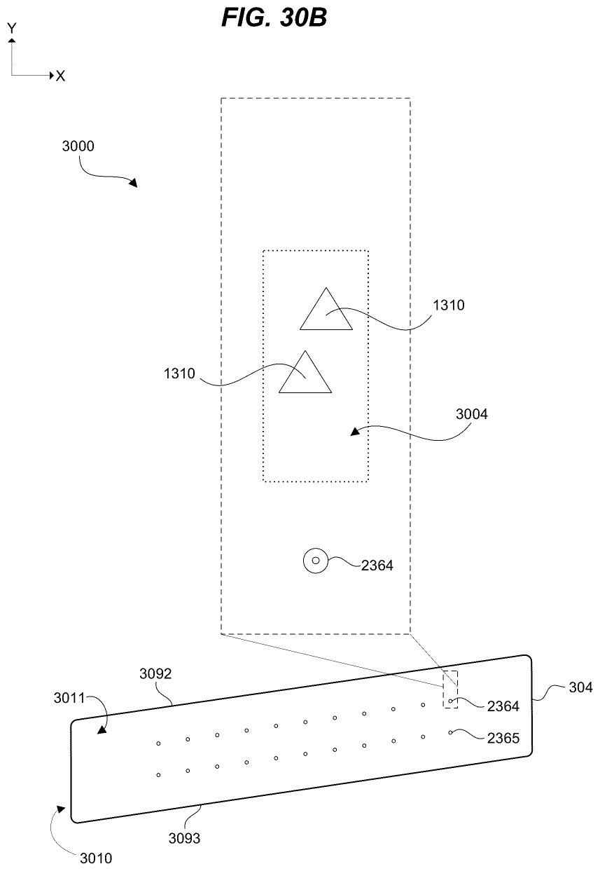

FIGS. 30A-30B are perspective views of nozzle plate 304 in illustrative embodiments. As described above, nozzle plate 304 is a substantially flat substrate, and thus has opposing surfaces 3010-3011 (and longitudinal sides 3092-3093). Surface 3010 comprises the discharge surface 220 of the printhead 104, while surface 3011 faces toward housing 230. Magnification window 3000 illustrates a magnified view of nozzle plate 304 corresponding with an individual jetting channel 402, and it is understood that the structure of nozzle plate 304 is similar for each jetting channel 402. Nozzle plate 304 includes a nozzle hole 2364 that forms at least part of a nozzle 306 of a jetting channel 402. A portion or region of surface 3011 (e.g., between nozzle hole 2364 and longitudinal side 3092) forms a wall of a channel fluid passage 820 or restrictor for a jetting channel 402, such as bottom wall 1803 as shown in FIGS. 18A-18B, and is referred to herein as a restrictor wall surface 3004. One or more fixed valve members 1310 may be disposed or formed on the restrictor wall surface 3004. In FIG. 30A, a single fixed valve member 1310 is disposed on the restrictor wall surface 3004. In FIG. 30B, a plurality of fixed valve members 1310 are disposed on the restrictor wall surface 3004. The fixed valve member(s) 1310 projects from restrictor wall surface 3004 of nozzle plate 304 in a region of nozzle plate 304 that coincides with a restrictor opening 2734 of restrictor plate 2703. In an embodiment, the restrictor wall surface 3004 of nozzle plate 304 may be etched or patterned with the fixed valve member(s) 1310. In an embodiment, the fixed valve member(s) 1310 may be formed or patterned on the restrictor wall surface 3004 of nozzle plate 304 with an additive manufacturing process or the like. One technical benefit is passive valves 1102 may be defined in channel fluid passages.

As described above, passive valves 1102 may be disposed in one or more manifolds 518/818 of a printhead 104. Thus, fixed valve members 1310 may be fabricated on one or more plates to form the passive valves 1102 in the manifolds 518/818, similar to what is described above for the channel fluid passages 520/820 yielding analogous technical benefits as described earlier.

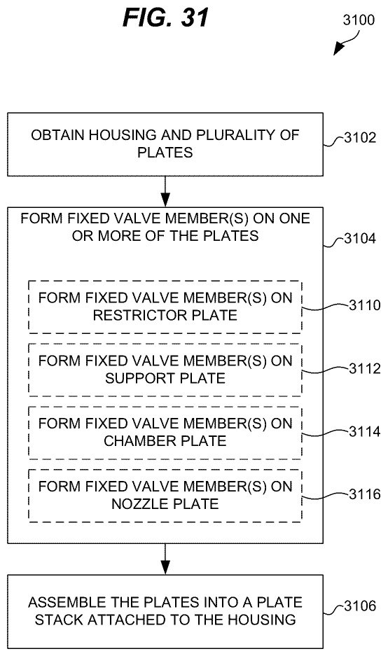

FIG. 31 is a flow chart illustrating a method 3100 of fabricating a printhead 104 in an illustrative embodiment. The steps of the flow charts described herein are not all inclusive and may include other steps not shown, and the steps may be performed in an alternative order. Method 3100 comprises obtaining a housing 230 and a plurality of plates (step 3102), such as described above for a printhead 104. For example, the plates may comprise a diaphragm plate 2301, a support plate 2302, a restrictor plate 2303, chamber plates 2304-2305, and a nozzle plate 304 as described in FIG. 23. In another example, the plates may comprise a diaphragm plate 2301, a support plate 2302, a first restrictor plate 2303, chamber plates 2304-2305, a second restrictor plate 2703, and a nozzle plate 304 as described in FIG. 27.

Method 3100 further comprises forming one or more fixed valve members 1310 on one or more of the plates (step 3104). For example, one or more fixed valve members 1310 may be formed on a restrictor plate 2303/2703, such as shown in FIGS. 24A-24B and FIGS. 28A-28B (optional step 3110). In another example, one or more fixed valve members 1310 may be formed on a support plate 2302, such as shown in FIGS. 25A-25B (optional step 3112). In another example, one or more fixed valve members 1310 may be formed on a chamber plate 2304/2305, such as shown in FIGS. 26A-26B and FIGS. 29A-29B (optional step 3114). In yet another example, one or more fixed valve members 1310 may be formed on a nozzle plate 304, such as shown in FIGS. 30A-30B (optional step 3116). Fixed valve members 1310 may be formed or fabricated on a plate of a printhead 104 using a variety of fabrication processes. In an embodiment, a fixed valve member(s) 1310 may be formed with an etching or patterning process, with an additive manufacturing process, etc.

Method 3100 further comprises assembling the plates into a plate stack 232 attached to the housing 230 (step 3106). For example, the plates may be bonded or otherwise affixed to one another to form a plate stack 232, such as with an adhesive or bonding material. Similarly, the plate stack 232 may be bonded or otherwise affixed to the housing 230, such as with an adhesive or bonding material. The plate stack 232 affixed to the housing 230 comprises an assembled printhead 104. When assembled, the printhead 104 has a structure according to embodiments described above. Due to the fixed valve member(s) 1310 formed or fabricated on one or more of the plates, passive valves 1102 are disposed in one or more channel fluid passages 520/820 of the jetting channels, and may also be disposed in one or more manifolds 518/818 of the printhead 104. One technical benefit is the passive valves 1102 reduce pressure drop in the pressure chambers 412. Thus, lower voltages may be used for jetting from jetting channels 402, which makes a printhead 104 more efficient.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a printhead comprising a housing, and a plate stack attached to the housing that forms: a plurality of jetting channels comprising pressure chambers and channel fluid passages that fluidly couple the pressure chambers to a common manifold, and passive valves disposed in the channel fluid passages. The passive valves are configured to inhibit a back flow of print liquid from the pressure chambers towards the common manifold and allow a flow of the print liquid from the common manifold towards the pressure chambers. At least one plate of the plate stack comprises fixed valve members that are disposed within the channel fluid passages to form the passive valves.

Example 2 includes the subject matter of Example 1, where, for a channel fluid passage of an individual jetting channel, at least one fixed valve member of the fixed valve members is disposed between opposing side walls of the channel fluid passage, and physical separations between the at least one fixed valve member and the side walls are configured to form flow paths on opposing sides of the at least one fixed valve member.

Example 3 includes the subject matter of Examples 1 and 2, where a cross-section of the at least one fixed valve member has a generally triangular shape.

Example 4 includes the subject matter of Examples 1-3, where the at least one fixed valve member is disposed closer to a first one of the side walls than a second one of the side walls.

Example 5 includes the subject matter of Examples 1-4, where the at least one fixed valve member is positioned closer to an opening to a pressure chamber than an opening to the common manifold.

Example 6 includes the subject matter of Examples 1-5, where the at least one fixed valve member comprises a first fixed valve member and a second fixed valve member, and the first fixed valve member is disposed within the channel fluid passage closer than the second fixed valve member to an opening to a pressure chamber.

Example 7 includes the subject matter of Examples 1-6, where the first fixed valve member and the second fixed valve member do not overlap in a widthwise direction.

Example 8 includes the subject matter of Examples 1-7, where the first fixed valve member and the second fixed valve member at least partially overlap in a lengthwise direction.

Example 9 includes the subject matter of Examples 1-8, where the first fixed valve member is offset from a longitudinal centerline of the channel fluid passage in a first widthwise direction, and the second fixed valve member is offset from the longitudinal centerline of the channel fluid passage in a second widthwise direction opposite the first widthwise direction.

Example 10 includes the subject matter of Examples 1-9, where the plate stack includes: a diaphragm plate that forms diaphragms of the jetting channels, a support plate, a restrictor plate having restrictor openings that form at least part of the channel fluid passages, a first chamber plate and a second chamber plate that form at least part of the pressure chambers, and a nozzle plate having nozzle holes that define nozzles of the jetting channels.

Example 11 includes the subject matter of Examples 1-10, where the restrictor plate includes: valve structures that extend across the restrictor openings, where the valve structures each comprise a support element, and one or more of the fixed valve members disposed on the support element. Each of the fixed valve members has a width less than a width of the restrictor openings.

Example 12 includes the subject matter of Examples 1-11, where the first chamber plate includes: chamber openings that form at least part of the pressure chambers, and one or more of the fixed valve members projecting from a surface of the first chamber plate in regions of the first chamber plate, between the chamber openings and a longitudinal side of the first chamber plate, that coincide with the restrictor openings.

Example 13 includes the subject matter of Examples 1-12, where the support plate includes: chamber openings that form at least part of the pressure chambers, and one or more of the fixed valve members projecting from a surface of the support plate in regions of the support plate, between the chamber openings and a longitudinal side of the support plate, that coincide with the restrictor openings.

Example 14 includes the subject matter of Examples 1-13, where the channel fluid passages comprise first channel fluid passages, the common manifold comprises a first common manifold, the plate stack forms second channel fluid passages for the jetting channels that fluidly couple the pressure chambers to a second common manifold, and the passive valves are further disposed in the second channel fluid passages, configured to inhibit a back flow of print liquid from the second common manifold towards the pressure chambers and allow a flow of the print liquid from the pressure chambers towards the second common manifold. The restrictor plate comprises a first restrictor plate, and the plate stack further includes a second restrictor plate having restrictor openings that form at least part of the second channel fluid passages.

Example 15 includes the subject matter of Examples 1-14, where the second restrictor plate includes: valve structures that extend across the restrictor openings of the second restrictor plate, where the valve structures each comprise a support element, and one or more of the fixed valve members disposed on the support element. Each of the fixed valve members has a width less than a width of the restrictor openings of the second restrictor plate.

Example 16 includes the subject matter of Examples 1-15, where the second chamber plate includes: chamber openings that form at least part of the pressure chambers, and one or more of the fixed valve members projecting from a surface of the second chamber plate in regions of the second chamber plate, between the chamber openings and a longitudinal side of the second chamber plate, that coincide with the restrictor openings of the second restrictor plate.

Example 17 includes the subject matter of Examples 1-16, where the nozzle plate includes: the nozzle holes, and one or more of the fixed valve members projecting from a surface of the nozzle plate in regions of the nozzle plate, between the nozzle holes and a longitudinal side of the nozzle plate, that coincide with the restrictor openings of the second restrictor plate.

Example 18 includes the subject matter of Examples 1-17, where a jetting apparatus comprises the printhead.

Some embodiments pertain to Example 19 that includes a printhead comprising a housing, and a plate stack attached to the housing that forms: a plurality of jetting channels comprising pressure chambers, first channel fluid passages that fluidly couple the pressure chambers to a first common manifold, and second channel fluid passages that fluidly couple the pressure chambers to a second common manifold, and passive valves comprising first passive valves disposed in the first channel fluid passages, the first passive valves configured to inhibit a back flow of print liquid from the pressure chambers towards the first common manifold and allow a flow of the print liquid from the first common manifold towards the pressure chambers, and second passive valves disposed in the second channel fluid passages, the second passive valves configured to inhibit a back flow of the print liquid from the second common manifold towards the pressure chambers and allow a flow of the print liquid from the pressure chambers towards the second common manifold. A first plate of the plate stack comprises fixed valve members that are disposed within the first channel fluid passages to form the first passive valves, and a second plate of the plate stack comprises the fixed valve members that are disposed within the second channel fluid passages to form the second passive valves.

Example 20 includes the subject matter of Example 19, where the plate stack includes: a diaphragm plate that forms diaphragms of the jetting channels, a support plate, a first restrictor plate having restrictor openings that form at least part of the first channel fluid passages, a first chamber plate and a second chamber plate that form at least part of the pressure chambers, a second restrictor plate having restrictor openings that form at least part of the second channel fluid passages, and a nozzle plate having nozzle holes that define nozzles of the jetting channels.

Example 21 includes the subject matter of Examples 19 and 20, where the first restrictor plate includes: valve structures that extend across the restrictor openings of the first restrictor plate, where the valve structures each comprise a support element, and one or more of the fixed valve members disposed on the support element. Each of the fixed valve members has a width less than a width of the restrictor openings of the first restrictor plate.

Example 22 includes the subject matter of Example 19-21, where the second restrictor plate includes: valve structures that extend across the restrictor openings of the second restrictor plate, where the valve structures each comprise a support element, and one or more of the fixed valve members disposed on the support element. Each of the fixed valve members has a width less than a width of the restrictor openings of the second restrictor plate.

Some embodiments pertain to Example 23 that includes a method of fabricating a printhead, the method comprising: obtaining a housing and a plurality of plates for the printhead, forming fixed valve members on one or more of the plates, and assembling the plates into a plate stack attached to the housing. The plate stack when assembled forms: a plurality of jetting channels comprising pressure chambers and channel fluid passages that fluidly couple the pressure chambers to a common manifold, and passive valves disposed in the channel fluid passages, the passive valves configured to inhibit a back flow of print liquid from the pressure chambers towards the common manifold and allow a flow of the print liquid from the common manifold towards the pressure chambers. The fixed valve members disposed within the channel fluid passages form the passive valves.

Although specific embodiments were described herein, the scope of the invention is not limited to those specific embodiments. The scope of the invention is defined by the following claims and any equivalents thereof.

What is claimed is:

1. A printhead comprising:
a housing; and
a plate stack attached to the housing that forms:
a plurality of jetting channels comprising pressure chambers and channel fluid passages that fluidly couple the pressure chambers to a common manifold; and
passive valves disposed in the channel fluid passages, the passive valves configured to inhibit a back flow of print liquid from the pressure chambers towards the common manifold and allow a flow of the print liquid from the common manifold towards the pressure chambers;
wherein at least one plate of the plate stack comprises fixed valve members that are disposed within the channel fluid passages to form the passive valves.

2. The printhead of claim 1, wherein:
for a channel fluid passage of an individual jetting channel, at least one fixed valve member of the fixed valve members is disposed between opposing side walls of the channel fluid passage, and physical separations between the at least one fixed valve member and the side walls are configured to form flow paths on opposing sides of the at least one fixed valve member.

3. The printhead of claim 2, wherein:
a cross-section of the at least one fixed valve member has a generally triangular shape.

4. The printhead of claim 2, wherein:
the at least one fixed valve member is disposed closer to a first one of the side walls than a second one of the side walls.

5. The printhead of claim 2, wherein:
the at least one fixed valve member is positioned closer to an opening to a pressure chamber than an opening to the common manifold.

6. The printhead of claim 2, wherein:
the at least one fixed valve member comprises a first fixed valve member and a second fixed valve member; and
the first fixed valve member is disposed within the channel fluid passage closer than the second fixed valve member to an opening to a pressure chamber.

7. The printhead of claim 6, wherein:
the first fixed valve member and the second fixed valve member do not overlap in a widthwise direction.

8. The printhead of claim 6, wherein:
the first fixed valve member and the second fixed valve member at least partially overlap in a lengthwise direction.

9. The printhead of claim 6, wherein:
the first fixed valve member is offset from a longitudinal centerline of the channel fluid passage in a first widthwise direction; and
the second fixed valve member is offset from the longitudinal centerline of the channel fluid passage in a second widthwise direction opposite the first widthwise direction.

10. The printhead of claim 1, wherein the plate stack includes:
a diaphragm plate that forms diaphragms of the jetting channels;
a support plate;
a restrictor plate having restrictor openings that form at least part of the channel fluid passages;
a first chamber plate and a second chamber plate that form at least part of the pressure chambers; and
a nozzle plate having nozzle holes that define nozzles of the jetting channels.

11. The printhead of claim 10, wherein the restrictor plate includes:
valve structures that extend across the restrictor openings, wherein
the valve structures each comprise a support element, and one or more of the fixed valve members disposed on the support element; and
each of the fixed valve members has a width less than a width of the restrictor openings.

12. The printhead of claim 10, wherein the first chamber plate includes:
chamber openings that form at least part of the pressure chambers; and
one or more of the fixed valve members projecting from a surface of the first chamber plate in regions of the first chamber plate, between the chamber openings and a longitudinal side of the first chamber plate, that coincide with the restrictor openings.

13. The printhead of claim 10, wherein the support plate includes:
chamber openings that form at least part of the pressure chambers; and
one or more of the fixed valve members projecting from a surface of the support plate in regions of the support plate, between the chamber openings and a longitudinal side of the support plate, that coincide with the restrictor openings.

14. The printhead of claim 10, wherein:
the channel fluid passages comprise first channel fluid passages;
the common manifold comprises a first common manifold;
the plate stack forms second channel fluid passages for the jetting channels that fluidly couple the pressure chambers to a second common manifold;
the passive valves are further disposed in the second channel fluid passages, the passive valves configured to inhibit a back flow of print liquid from the second common manifold towards the pressure chambers and allow a flow of the print liquid from the pressure chambers towards the second common manifold;
the restrictor plate comprises a first restrictor plate; and
the plate stack further includes a second restrictor plate having restrictor openings that form at least part of the second channel fluid passages.

15. The printhead of claim 14, wherein the second restrictor plate includes:
valve structures that extend across the restrictor openings of the second restrictor plate, wherein
the valve structures each comprise a support element, and one or more of the fixed valve members disposed on the support element; and
each of the fixed valve members has a width less than a width of the restrictor openings of the second restrictor plate.

16. The printhead of claim 14, wherein the second chamber plate includes:
chamber openings that form at least part of the pressure chambers; and
one or more of the fixed valve members projecting from a surface of the second chamber plate in regions of the second chamber plate, between the chamber openings and a longitudinal side of the second chamber plate, that coincide with the restrictor openings of the second restrictor plate.

17. The printhead of claim 14, wherein the nozzle plate includes:
the nozzle holes; and
one or more of the fixed valve members projecting from a surface of the nozzle plate in regions of the nozzle plate, between the nozzle holes and a longitudinal side of the nozzle plate, that coincide with the restrictor openings of the second restrictor plate.

18. A jetting apparatus comprising:
the printhead of claim 1.

19. A printhead comprising:
a housing; and
a plate stack attached to the housing that forms:
a plurality of jetting channels comprising pressure chambers, first channel fluid passages that fluidly couple the pressure chambers to a first common manifold, and second channel fluid passages that fluidly couple the pressure chambers to a second common manifold; and
passive valves comprising:
first passive valves disposed in the first channel fluid passages, the first passive valves configured to inhibit a back flow of print liquid from the pressure chambers towards the first common manifold and allow a flow of the print liquid from the first common manifold towards the pressure chambers; and
second passive valves disposed in the second channel fluid passages, the second passive valves configured to inhibit a back flow of the print liquid from the second common manifold towards the pressure chambers and allow a flow of the print liquid from the pressure chambers towards the second common manifold, wherein
a first plate of the plate stack comprises fixed valve members that are disposed within the first channel fluid passages to form the first passive valves, and a second plate of the plate stack comprises the fixed valve members that are disposed within the second channel fluid passages to form the second passive valves.

20. The printhead of claim 19, wherein the plate stack includes:
a diaphragm plate that forms diaphragms of the jetting channels;
a support plate;
a first restrictor plate having restrictor openings that form at least part of the first channel fluid passages;
a first chamber plate and a second chamber plate that form at least part of the pressure chambers;
a second restrictor plate having restrictor openings that form at least part of the second channel fluid passages; and
a nozzle plate having nozzle holes that define nozzles of the jetting channels.

21. The printhead of claim 20, wherein the first restrictor plate includes:
valve structures that extend across the restrictor openings of the first restrictor plate, wherein
the valve structures each comprise a support element, and one or more of the fixed valve members disposed on the support element; and
each of the fixed valve members has a width less than a width of the restrictor openings of the first restrictor plate.

22. The printhead of claim 20, wherein the second restrictor plate includes:
valve structures that extend across the restrictor openings of the second restrictor plate, wherein
the valve structures each comprise a support element, and one or more of the fixed valve members disposed on the support element; and
each of the fixed valve members has a width less than a width of the restrictor openings of the second restrictor plate.

23. A method of fabricating a printhead, the method comprising:
obtaining a housing and a plurality of plates for the printhead;
forming fixed valve members on one or more of the plates; and
assembling the plates into a plate stack attached to the housing, wherein
the plate stack when assembled forms:
a plurality of jetting channels comprising pressure chambers and channel fluid passages that fluidly couple the pressure chambers to a common manifold; and
passive valves disposed in the channel fluid passages, the passive valves configured to inhibit a back flow of print liquid from the pressure chambers towards the common manifold and allow a flow of the print liquid from the common manifold towards the pressure chambers;
wherein the fixed valve members disposed within the channel fluid passages form the passive valves.
